(19) United States
(12) Patent Application Publication
(10) Pub. No.: US 2026/0093099 A1
(43) Pub. Date: Apr. 2, 2026

(54) LONG WORKING DISTANCE AIR OBJECTIVE FOR MULTIPHOTON MICROSCOPY

(71) Applicant: The Regents of the University of California, Oakland, CA (US)

(72) Inventors: Spencer LaVere Smith, Santa Barbara, CA (US); Che-Hang Yu, Santa Barbara, CA (US)

(21) Appl. No.: 19/257,345

(22) Filed: Jul. 1, 2025

Related U.S. Application Data
(60) Provisional application No. 63/676,785, filed on Jul. 29, 2024.

(51) Int. Cl. G02B 21/02; G02B 9/64

(52) U.S. Cl. CPC G02B 21/02; G02B 9/64

(57) ABSTRACT

A microscope objective having proximal and distal ends comprises a plurality of lenses including a lens element closest to the proximal end, a lens element closest to said distal end and a plurality of lens elements therebetween. At least one of the lenses has a clear aperture of larger than 35 mm. The microscope objective has a working distance of between 8 mm and 14 mm and a numerical aperture of between 0.55 and 0.65 in air.

### CROSS-REFERENCE TO RELATED PATENT APPLICATIONS

This application claims the benefit of priority of U.S. Provisional Application No. 63/676,785 titled “LONG WORKING DISTANCE AIR OBJECTIVE FOR MULTIPHOTON MICROSCOPY,” filed Jul. 29, 2024. The entirety of each application referenced in this paragraph is incorporated herein by reference.

### FEDERALLY SPONSORED RESEARCH OR DEVELOPMENT

This invention was made with Government support under MH136563 awarded by National Institute of Health. The Government has certain rights in the invention.

### BACKGROUND

### Field

The present disclosure relates generally to microscope objectives, and more specifically large numerical aperture (NA), large working distance microscope objectives, e.g., microscope objective having an NA of at least 0.55 and a working distance of 8 mm or more in air, which may potentially find use in fluorescence microscopy such as one-photon, two-photon, and three-photon microscopy as well as non-fluorescence microscopy.

### Description of the Related Art

Microscopes such as fluorescence microscopes with large working distance and large numerical aperture can be used for a wide range of applications including biological and medical research. Large working distances can provide the ability to image objects with irregular (e.g., non-flat) topographic structure, as opposed to flat samples, and potentially in vivo. For example, a large working distance microscope may be able to image the brain of a mouse when a portion of the skull has been removed to provide direct visual access to the brain, which may be useful for conducting neurological studies. The large working distance of the microscope, and, in particular, of the microscope objective, provides clearance for the sample (e.g., the mouse) to be scanned with respect to the microscope objective (e.g., in x and y directions and/or x, y and z as various two-photon microscope can use a 3-D imaging method with a virtual z sectioning capability and thus can perform volumetric imaging) while clearing the topographically varying anatomy of the mouse. In particular, larger animals such as ferrets and monkeys can have complex substantial anatomy (e.g., a thickly contoured cranium) that poses mechanical challenges to short working distance microscope objectives. Moreover, other applications such as imaging in eyes or other complex arrangements, including non-biological samples, can benefit from long working distances.

Fluorescence microscopes are valuable tools in biology and medicine, providing the ability to image and identify specific structures or regions within tissue. To produce fluorescence, light having a first wavelength is directed onto the sample. Certain regions of the sample, possibly regions of the sample where fluorescent dye (e.g., comprising a fluorophore) or fluorescent protein, or other fluorescent species has accumulated, may output light of a second different wavelength as a result of a fluorescence process. Molecules may be excited to a higher energy state by the light directed onto the sample. These molecules may transition to a lower energy state emitting light of a different wavelength in the process. A variety of fluorescence mechanisms and processes are possible. Two-photon fluorescence microscopy is one example of a powerful microscopy technique based on fluorescence where the sample is exposed to long wavelength light that excites molecules (possibly fluorophores injected into the tissue or genetically expressed) into a higher energy state and the molecules emit light of a shorter wavelength that is about half of the wavelength of the excitation illumination. In such applications, the fluorophore absorbs two photons of the excitation light, hence the reference to two photons.

Such fluorescence techniques may produce relatively low levels of emission. Photomultiplier tubes and various photon detection devices may be employed to detect such limited optical signals. Large numerical aperture (NA) microscope objectives, which can collect more light than small numerical aperture objective, thus can also be helpful.

### SUMMARY

The present disclosure relates generally to microscope objectives and microscopes, and in particular, to microscopes and microscope objectives with high numerical apertures (NAs) and long working distances, such as NAs greater than 0.5 and working distances greater than 8 mm in air, as well as methods regarding same. Various devices, apparatus, methods, and systems described herein may be used for microscopy such as fluorescence microscopy and/or two-photon microscopy. The objective, however, can be used for a wide range of different types of microscopy including but not limited to nonlinear microscopy including fluorescence modalities (e.g., two-photon microscopy, three-photon microscopy, or multiphoton microscopy) and non-fluorescence based modalities (second-harmonics generation microscopy, third-harmonics generation microscopy, and higher-harmonics generation microscopy; Raman microscopy such as stimulated Raman scattering (SRS) microscopy, coherent anti-stoke Raman scattering (CARS) microscopy). Still other applications for this objective are possible.

For example, one such microscope objective having a first proximal end and a second distal end, with distal end configured to be closer to a sample than the proximal end, comprises first, second, third and fourth stages. The first stage comprises a diverging lens element having negative optical power such that collimated light incident on the diverging lens element is caused by the diverging lens element to diverge as said light propagates away from the diverging lens element in the direction of the distal end of said microscope objective. The second stage comprises a lens configured to receive the diverging beam and to cause the diverging beam to begin to converge from the widest lateral extent of the beam in the microscope objective or be collimated. The second stage is more distal than the first stage. The third stage comprises multiple lens elements and is more distal than the second stage such that the lens in said second stage is located between the diverging lens element in the first stage and the multiple lens elements in the third stage. The fourth stage comprises a distal focusing lens having positive optical power to focus the beam down. The distal focusing lens is the lens that is closest to the focus of the microscope objective where said collimated light incident on the proximal end of the microscope objective will be focused. The fourth stage is more distal than the third stage such multiple lens elements in the third stage is between said lens in the second stage and the distal focusing lens in the fourth stage. The microscope objective has a numerical aperture in the range from 0.55 to 0.65.

Also disclosed herein, is a microscope objective having a first proximal end and a second distal end (with the distal end configured to be closer to a sample than the proximal end) comprising seven lens elements having optical power within a housing arranged along a longitudinal optical path. The seven lens elements comprise a first lens element having negative optical power, a second lens element having positive optical power, and a third lens element having positive optical power. The second lens element is between said first lens element and the third lens element. The seven lens elements further comprise lens triplet comprising a fourth lens element, a fifth lens element, and a sixth lens, with the fifth lens element between the fourth lens element and the sixth lens element. The fourth and sixth lens elements have positive optical power and the fifth lens element has negative optical power. The seven lens elements additionally comprises a seventh lens element positioned to be closest said sample. The seventh lens element has positive optical power. The triplet is between the seventh lens element and the third lens element. The microscope objective has a working distance in a range from 8 mm to 16 mm and a numerical aperture of in a range from 0.50 to 0.65 in air.

Another a microscope objective described herein having a first proximal end and a second distal end (with the distal end configured to be closer to a sample than the proximal end) comprises a housing; and a plurality of lens elements having optical power within the housing. The plurality of lens elements are arranged along a longitudinal optical path within the housing. The plurality of lens elements includes a lens element closest to the proximal end, a lens element closest to the distal end and a plurality of lens elements therebetween. The microscope objective has a working distance in the range from 6 mm to 14 mm and a numerical aperture in the range from 0.55 to 0.65 in air.

As discussed above, various teachings of the present disclosure may be applicable to fluorescence microscopy such as two-photon microscopy as well as for other imaging and non-imaging applications to provide system performance advantages.

Although the microscope objective described herein may be employed for microscopy and other imaging applications, the objective may also be employed for non-imaging applications. Some such non-imaging applications include but are not limited to laser manufacturing, 3D printing, and polymerization such as two photon polymerization. Accordingly, the objective may be employed in non-imaging optical systems such as laser manufacturing systems, 3D printers, two photon polymerization systems or other polymerization systems. Even though such systems and/or applications do not necessarily comprises microscopes, the objective may be referred to as a microscope objective or possibly as an objective.

### BRIEF DESCRIPTION OF THE DRAWINGS

The drawings described herein are for illustrative purposes only of selected embodiments and not all possible implementations and are not intended to limit the scope of the present disclosure.

Corresponding reference numerals indicate corresponding parts throughout the several views of the drawings.

FIG. 1 is a schematic view of an example of laser scanning microscope such as a fluorescence microscope like a two-photon absorption laser scanning microscope.

FIG. 2 is a schematic view of a plurality of lenses included in a high numerical aperture, long working distance microscope objective that can be used for fluorescence microscopy such as two-photon laser scanning microscopy.

FIGS. 3A and 3B are tables providing an optical prescription for a high numerical aperture, long working distance microscope objective such as shown in FIG. 2. In addition to showing surface curvatures, thicknesses and clear aperture diameters, FIG. 3A lists the type of glass in the column labeled material while FIG. 3B lists the index of refraction and Abbe number in the same column.

FIG. 4A shows plots on axes of lateral position, Y (in degrees) versus longitudinal position, Z (in micrometers and millimeters, respectively) of the image field produced by the microscope objective design of FIGS. 3A and 3B showing minor deviation of the image field from the ideal image plane.

FIG. 4B shows plots on axes of wavelength, λ, (in micrometers, μm) versus shift in focus (in micrometers) produced by the microscope objective design of FIGS. 3A and 3B showing minor effects of longitudinal chromatic aberration.

FIGS. 5A and 5B are plots of RMS wavefront error (in waves) versus lateral position or field, Y, (in degrees) for the microscope objective design of FIGS. 3A and 3B.

FIGS. 6A and 6B are plots of Strehl Ratio (unitless) versus lateral position or field, Y, (in degrees) for the microscope objective design of FIGS. 3A and 3B.

### DETAILED DESCRIPTION

As discussed above, microscopes with large working distance can be used to image objects from sufficient distance to clear irregular or non-flat topographic features. The large working distance of the microscope, and, in particular, of the microscope objective, provides clearance for the sample to be scanned two or three dimensions, (e.g., in x and y directions or x, y and z directions) with respect to the microscope objective while clearing protruding topographical features of the sample or possibly of neighboring equipment or components. A large working distance may be advantageous for other scenarios as well potentially facilitating in vivo imaging.

The numerical aperture of a microscope objective is directly related to the light collection ability of the optics and the resolving power. Optics with a larger numerical aperture are capable of collecting more light, which can be helpful for applications like two-photon microscopy that rely on detection of relatively low amounts of light. Optics with a large numerical aperture also has a higher optical resolution, which is capable of better resolving structure of minute objects in detail and/or tightly focusing a beam onto a tiny portion a sample. Accordingly, various microscope objective designs described herein provide both high numerical aperture and long working distance.

Such microscope objectives may be used in microscopes including but not limited to scanning microscopes such as laser scanning microscopes wherein a laser beam is scanned across a sample and light from the sample is collected to produce a map of light intensity versus x-y position. In some cases, the light from the sample may be fluorescence produced by illuminating the sample with the laser light. One example of laser induced fluorescence microscope is two-photon microscopy. As discussed above, in two-photon microscopy, laser light directed onto a sample produces optical emission having about half of the wavelength of the incident laser light. As discussed above, in some cases, the fluorescence is produced by a dye or other agent such as a fluorophore, which is added to the sample, or by fluorescence proteins, which are genetically expressed from the bio-samples.

Also as discussed above, such fluorescence techniques may generate relatively low levels of emission. Large numerical aperture (NA) microscope objectives may assist in collecting the limited light produced. Large NAs can produce a highly focused beam with an extremely small spot size that can be scanned across a sample to provide for high resolution laser scanning microscopy.

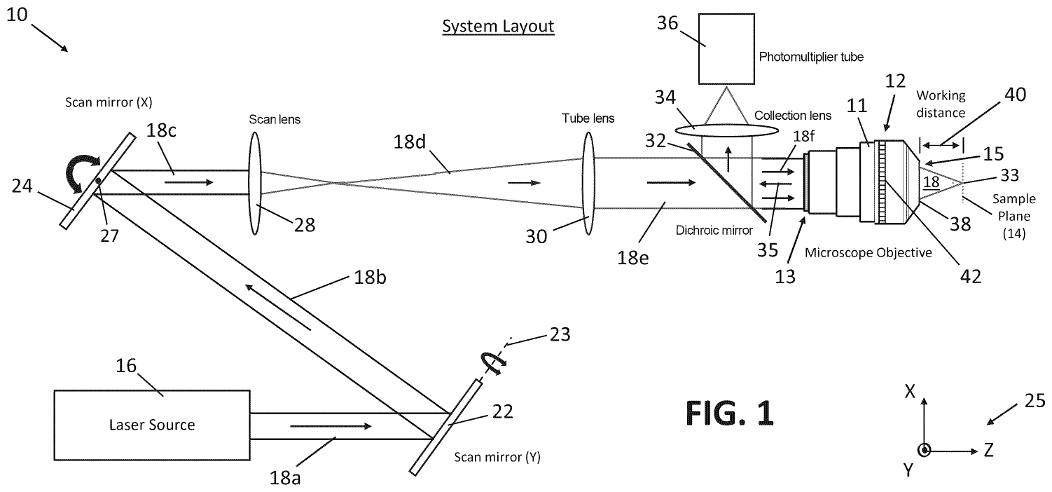

FIG. 1 shows an example laser scanning microscope 10. The laser scanning microscope 10 includes a microscope objective 12 positioned with respect to a sample (not shown) at least a portion of which may be located at the sample plane 14. The microscope objective 12 has a housing 11 as well as proximal and distal ends 13, 15. The distal end 15 is closer to the sample than the proximal end 13. As will be discussed below, light will be focused onto this sample plane 14 where the sample is situated. Similarly, light from the sample (e.g., resulting from fluorescence, possibly from a two-photon emission process) located at this sample plane will be collected by the microscope objective 12.

FIG. 1 shows a laser light source 16 for providing input light beam 18a to an optical system 10 configured to transform the input light beam 18a to illuminate the sample with a focused beam 18 that may, for example, be scanned. Although in this example of two-photon microscopy, a laser light source is employed, for other applications such as other types of microscopes and microscopies, such as one photon microscopy, other types of light sources (e.g., incoherent light sources) may be employed. Some non-limiting examples of other non-laser light sources include incandescent light sources such as incandescent lamps, arc lamps, light emitting diodes (LEDs), and similar types of light or photon sources. The laser light 18a output by the laser 16 is depicted as being collimated. In some cases, collimation optics is employed to produce such a collimated beam, however, the input light beam 18a is shown exiting the laser 12 collimated. As discussed above, this laser light (e.g., focused light beam or focused laser light beam) 18 may induce fluorescence in the sample, for example, in fluorophores within the sample. In various implementations, therefore, the laser light 18 has a wavelength appropriate to excite fluorescence or other processes to produce emission from the sample.

In various implementations, for example, the laser light is near infrared, NIR, such as from 910-930 nanometers (nm) and/or 1040-1060 nm or any portion of these bands. Other wavelengths and wavelength bands are possible. In general, a useful range of the excitation wavelength for two-photon microscopy and three-photon fluorescence imaging can be 700-1700 nm. One popular range is 700-1300 nm. The development of fluorophores, the laser technologies, and the properties of bio-tissues can further make the wavelengths around 920 nm (+/−10), 1050 nm (+/−10), and 1300 nm (+/−50) particularly useful. An example microscope objective 12 designed or optimized for 910-930 nm and 1040-1060 nm is discussed below. Although this microscope objective, by design, was not optimized outside of these two specific bands, it is diffraction-limited at the range of 910-1060 nm and possibly over a larger wavelength range.

In some cases, the laser light source 16 has a bandwidth of from 10-100 nm. Accordingly in various implementations, the microscope objective 12 is configured to transmit NIR wavelengths such as from 910-930 nanometers (nm) and/or 1040-1060 nm or any portion of these bands or possibly at other wavelengths. The microscope objective 12 may be designed for such wavelength, for example, to reduce aberration including possible chromatic aberration at the wavelengths of the laser light source 16. Accordingly, in various designs described herein the microscope objective 12 has optical correction such as wavefront aberration correction and/or chromatic aberration correction for wavelength in the NIR, such as 910-930 nm and/or 1040-1060 nm or any portion of these bands. In some implementations, for example, the microscope objective 12 is diffraction limited for these bands or possibly portions thereof.

In addition, the microscope objective 12 may transmit other wavelengths such as the wavelength of light from the sample. In some cases, this is visible light. Accordingly, the microscope objective 12 may be transmissive to both NIR light such as the wavelength(s) of light output by the laser source 16 as well as visible wavelengths. Although the microscope objective 12 may perform optically well in the visible wavelength, for some designs, the performance in the visible wavelength(s) need not be as high as at the wavelengths of the illumination light, for example, from the laser light source. In some applications, for example, where images are formed by scanning the illumination with respect to the sample (or vice versa) and collecting the light at different locations along the scan, the optical performance of the microscope objective 12 in imaging the sample need not be as high as the optical performance of the microscope and microscope objective in forming high resolution focused light beams from the laser light source onto the sample. A small spot size of the laser illumination provides for higher resolution imaging for such laser scanning microscopes.

To facilitate such scanning, the example scanning microscope 10 shown in FIG. 1 further includes first and second scanning mirrors 22, 24 configured to scan the input beam (e.g., the laser beam) 18a output by the laser 16 in X and Y directions. In particular, the first scanning mirror 22 is positioned to receive the input beam (e.g., the laser beam) 18a output by the laser and configured to tilt the mirror back and forth about an axis 23 so as to scan the beam in the Y direction. An XYZ coordinate system 25 shows the X, Y and Z directions for this example. The laser beam 18b reflected off this first scanning mirror 22 is thus swept back and forth in the Y direction. In various designs, two relay lenses (not shown) may also be included between the first and second scanning mirrors 22, 24. Such relay lens may form, for example, an afocal relay.

The second scanning mirror 24 is positioned to receive the laser beam 18b reflected from the first scanning mirror 22 and is configured to tilt this second mirror back and forth about an axis 27 so as to scan the beam 18c reflected therefrom in the X direction. As illustrated, this reflected beam 18c is directed to a scan lens 28, which relays the laser beam 18d to a tube lens 30. As illustrated, the scan lens 28 and the tube lens 30 form an afocal relay. As a result, the light beam 18e exits the tube lens 30 as a collimated beam in this example.

The tube lens 30 is disposed in an optical path between the scan mirrors 22, 24 and the microscope objective 12. The tube lens 30 therefore directs the laser beam 18e toward the microscope objective 12. A dichroic beamsplitter 32 is shown between the tube lens 30 and the microscope objective 12, and the laser beam 18e is shown passing through the dichroic beamsplitter. In this particular design, the dichroic beamsplitter 32 is transmissive to the laser beam 18, which is therefore transmitted therethough. See, e.g., beam 18f. As will be discussed below, beamsplitter 32 reflects light having a wavelength of fluorescent light emitted by the sample. (Other configurations, however, are possible. For example, in some other configurations, the beamsplitter 32 may reflect wavelengths of the laser beam 18 and transmit other wavelengths such as light emitted by the sample.) The laser beam 18f is incident on and coupled into the microscope objective 12. As discussed above, in this configuration, the laser beam 18f is collimated. Accordingly, the microscope objective 12 focuses the laser beam 18f down at the focal point 33 of the microscope objective 12, which can be at the sample plane 14 as shown in FIG. 1. This focal point 33 is at the focal plane of the microscope objective 12, where collimated light incident on the distal side 13 of the microscope objective 12 is focused. Likewise, the microscope objective 12 may be said to be infinity-corrected. In particular, various designs described herein are infinity corrected air objectives.

As discussed above, laser light 18 focused by the microscope objective 12 onto the sample (e.g., sample plane 14) may induce fluorescence which is emitted from the sample (e.g., possibly from fluorophores and/or a dye in the sample). The microscope objective 12 may collect a portion of this light (e.g., fluorescence light) emitted from the sample. As discussed above, having a high numerical aperture assists in collecting more of this light from the sample.

Light from the sample is incident on the distal end 15 of the microscope objective 12 and coupled therein. With the sample at the sample plane 14, light from the sample is collected light by the microscope objective 12. For example, the microscope objective 12 may capture a portion of light emitted by the sample in response to receiving the focused beam from the microscope objective 12. FIG. 1 shows the collected light exiting the proximal end 13 of the microscope objective 12 and directed back toward the dichroic beamsplitter 32. As discussed above, in this example, the dichroic beamsplitter 32 is configured to reflect light having the wavelength light (e.g., fluorescent light) emitted from the sample. In particular, the dichroic beamsplitter 32 directs light 35 from the sample toward a collecting lens 34 and an optical detector or sensor 36 such as a photomultiplier tube (PMT) for detection. The collecting lens 34 may, for example, focus the light 35 from the sample that is coupled into the microscope objective 12 and directed to the collecting lens, onto the optical sensor (e.g., PMT) 36. In various implementations, this optical sensor 36 is a point detector as opposed to an array, although in other implementations arrays, for example, for other applications, may be employed.

As discussed above, the laser beam 18 is scanned by the scanning mirrors 22, 24 in the X and Y directions. As a result, the laser beam 18 focused down onto the sample at the sample plane 14 will be scanned in X and Y. Light will be collected by the microscope objective 12 and detected by the optical sensor (e.g., PMT) 36 as the beam 18 is scanned across the sample. By recording the amount of light collected with respect to position of the scanned laser beam on the sample, a map of light collected may be produced. This map may show, for example, what portions of the sample produce, e.g., by fluorescence, more light than other portions of the sample. Fluorescence images or other types of images of the sample may thereby be generated.

Also, as discussed above, having a long working distance can be beneficial in imaging samples despite topographical variations on the sample or other obstructions such as equipment, etc., that may prevent the microscope objective 12 from getting sufficiently close to the sample to effectively image the sample. In FIG. 1, the working distance 40 is shown as the distance from the most distal portion (e.g., surface) 38 of the microscope objective 12 to the focus or focal point 33 of the microscope objective. The working distance 40 is also shown as the distance from the most distal portion (e.g., surface) 38 of the microscope objective 12 to the sample plane 14, which as discussed above, generally coincides with the focus/focal plane 33 of the microscope objective in various implementations.

In various implementations, the microscope objective 12 may be adjustable so as to compensate or reduce spherical aberration caused by the refractive index change from the air-to-glass-to-sample interfaces and the thickness of these different materials. In certain designs, for example, the housing 11 of the microscope objective 12 includes a rotatable collar 42 that can be rotated to implement such adjustment. In some designs, one or more optical elements (e.g., lenses) within the microscope objective 12 may be translated (e.g., in the longitudinal, Z, direction) to adjust the magnitude of the compensation for spherical aberration. For example, in some designs, one or more lenses within the microscope objective 12 may be translated when the collar 42 on the housing 11 is rotated. In various designs, of the translation distance of the lens or the lens group from 0 to 1 or 0 to 2 millimeters (mm) can be made. Adjustment to accommodate a cover slip of from 0-0.35 mm can also be made. Other configurations, however, are possible.

As illustrated in FIG. 1, the microscope objective 12 can be used simultaneously to focus light onto the sample, for example, to stimulate an optical response such as a fluorescence response, as well as to collect light, such as to collect fluorescence light. As discussed above, for some applications, the illumination is in the infrared such as NIR (e.g., 910-930 and/or 1040-1060) while the light collected is visible light. Likewise, the microscope objective 12 is suitable for two-photon imaging and two-photon optosimulation simultaneously. The microscope objective can also be suitable for SWIR, e.g., light in in a range of about 0.9-2.5 microns that can be used for various types of imaging (e.g., studying paintings, artifacts, security, product quality control, etc.).

FIG. 1 shows one configuration of a laser scanning microscope 10 such as a laser scanning fluorescence microscope or 2-photon laser scanning microscope, however, other configurations are possible. Different optical components and different arrangements may be used. For example, as discussed above, the light source need not be a laser light source, for example, when the objective is used for other applications besides laser scanning microscopy such as one photon applications. The light source may, for example, comprise one or more light emitting diodes (LED)s, lamps, or other types of photon sources. Additionally, although the microscope objective 12 is described herein in the context of a laser scanning microscope such as a laser scanning fluorescence microscope or two photon microscope, the microscope objective can be used for different applications and need not be so limited. Some examples of other applications include dark field, bright field microscopy, and photoacoustic microscopy. Some of the applications for which the microscope objective 12 may be employed include, but are not limited to, nonlinear microscopies such as for example multiphoton microscopy (2-photon, 3-photon, and so forth), harmonics generation microscopy (second-harmonics, three-harmonics, and higher-harmonics), stimulated Raman scattering (SRS) microscopy, and coherent anti-stoke Raman scattering (CARS) microscopy. The microscope objective 12 may also be employed for short wave infrared (SWIR) microscopy imaging. As referenced above, SWIR light may be light in in a range of about 0.9-2.5 microns and can be used for various types of imaging (e.g., studying paintings, artifacts, security, product quality control, etc. Accordingly, in such applications the system (e.g., microscope) may include an SWIR light source.

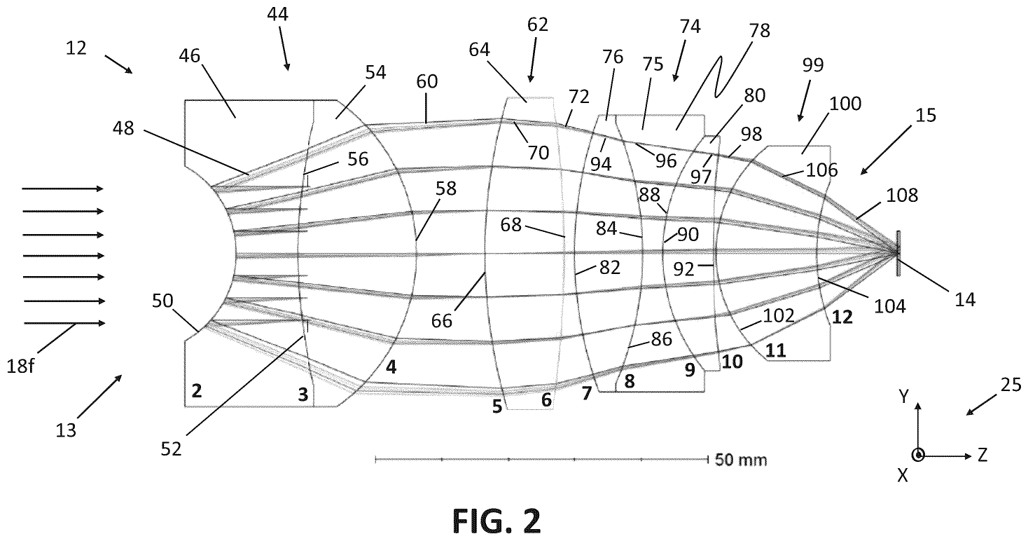

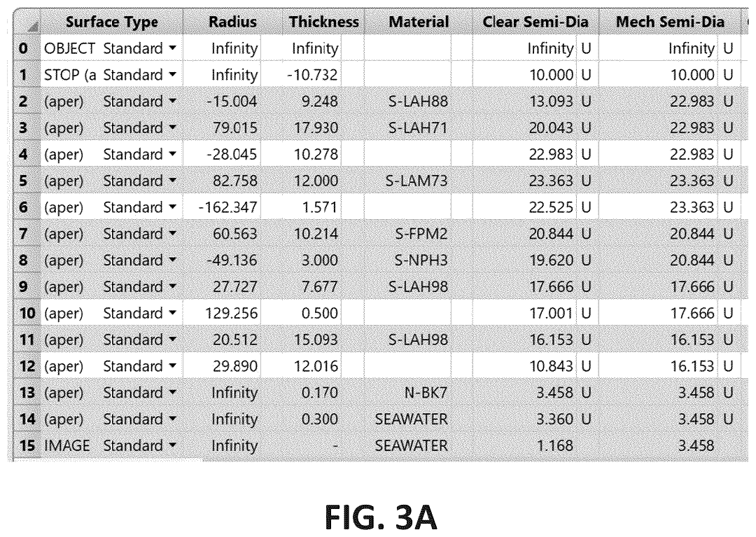

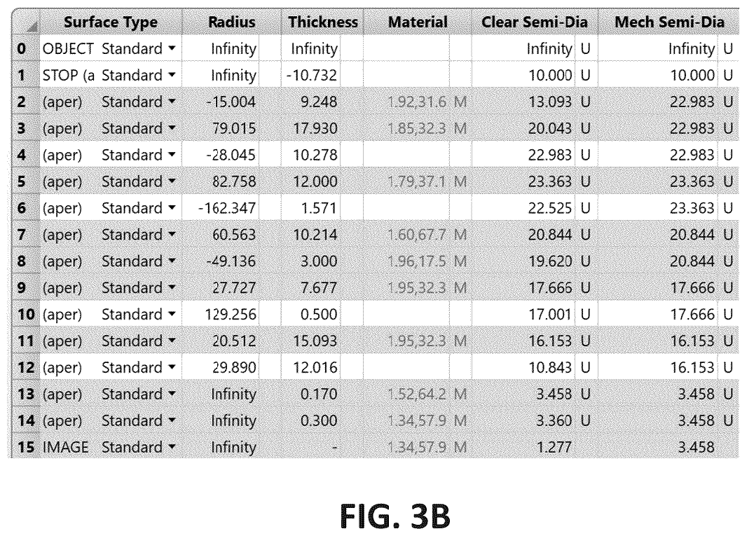

An example microscope objective design having a large numerical aperture (NA) and long working distance 40 is shown in FIG. 2 as well as detailed in the tables in FIGS. 3A and 3B. The tables include details of the optical prescription. The tables list, for example, the different surfaces, e.g., optical surfaces, of the lenses in the microscope objective 12 and provide design parameters associated therewith. The surfaces or optical surfaces are numbers on the leftmost column of the tables in FIGS. 3A and 3B as well as in FIG. 2 (in bold). The parameters listed in the table include the radius of curvature (under “Radius”) of the various surfaces as well as the thickness of the lenses and the distance therebetween (under “Thickness”). The radius of curvature and thickness are in unit of millimeters (mm). The material (from Ohara Corporation) is listed (under “Material”) in the table in FIG. 3A, while the index of refraction and Abbe number, which are unitless, are provided in the same column in the table in FIG. 3B. The tables also provide information regarding the clear aperture size (under clear semi-diameter). The table lists half the clear aperture or the area of the optical surface through which the beam may propagate. This number is to be multiplied by two (2) to obtain the diameter (which is a measure of the lateral spatial extent, e.g., in X or Y direction, of the beam through the lens surface and/or of the optical surface). Accordingly, the clear aperture is for the optical surface, which is of sufficient optical quality for the light to propagate. The mechanical semi-diameter, however, is also listed. This mechanical semi-diameter is half the diameter of the lens which may be larger than the beam propagating through the lens at that optical surface and larger than the optical surface through which the light propagates. Again, this number is to be multiplied by two (2) to obtain the diameter (which is a measure of the lateral spatial extent, e.g., in X or Y direction). The clear semi-diameter and mechanical semi-diameter are in units of millimeters (mm). The SEAWATER variable in ZEMAX is used as an approximation for brain tissue. The SEAWATER variable has an index of refraction close to the average index of refraction of the brain. The scattering characteristics may not be accounted for and the index of refraction changes a lot between the intracellular and extracellular solutions and lipid membranes. Nevertheless, SEAWATER is a useful approximation for ray tracing.

The microscope objective 12 includes a plurality of lenses and/or lens elements configured to provide for a high numerical aperture and a long working distance 40. However, performance parameters are balanced to obtain such numerical aperture and working distance. For example, to some extent, the increase in numerical aperture is achieved at the expense of a larger working distance. For example, in various implementations, when the numerical aperture increases, the focal length is decreased for a given the input beam size. A decease in the focal length can place a constraint on the length of working distance. Nevertheless, in various designs such as described herein, the numerical aperture, nevertheless, is sufficiently large. In various implementations, the effective focal length is 16.8 mm. In various implementation the microscope objective 12 has a focal length of 10 mm, 11 mm, 12 mm, 13 mm, 14 mm, 15 mm, 16 mm, 17 mm, 18 mm, 19 mm, 20 mm, 21 mm, 22 mm, 24 mm, 25 mm or any range formed by any of these values or possible larger or smaller.

The design includes the use of large clear apertures to enhance light collection ability. In particular, to enhance the photon collection efficiency, a large numerical aperture may be beneficial. Combining with the large working distance feature, the large numerical aperture design entails large diameters of lenses. The larger diameters lenses assists in providing larger numerical aperture and/or longer working distance. The largest lens is toward the middle with the smallest lens at the distal end 15 in some designs, (although in some implementations the lens at the proximal end could be the smallest or may be elsewhere in yet other designs). The housing 11 is large enough to accommodate the large lens diameters, however, at the proximal end 13, standard threading may be provided. In various designs, for example, M32×0.75 threads are at the proximal end of the microscope objective 12 and/or housing 11. Clearance at the proximal end 13 can be beneficial for mounting the objective 12 to the microscope nosepiece, where space is often limited. The housing 11 may have reduced size and/or material around the proximal end 13, yet the housing is configured to hold the lens and provide the mounting thread. The lateral size, e.g., diameter, of the most proximal lens 46 in FIG. 2 is also decreased, e.g., minimized, to increase the clearance and enable the commonly used M32×0.75 threads. Similarly, clearance around the distal end 15 can facilitate the operation of in vivo imaging and offer more accessible space for other gauging probes (e.g. patching). Additionally, to increase the clearance around this area, the edge of the most distal lens 100 may be tapered.

To accommodate such large lenses in the microscope objective 12, the housing 11 may have lateral extent (e.g., diameter) at the largest part of the objective that is at least 40 mm, 45 mm, 50 mm, 55 mm, 60 mm 65 mm, 70 mm, 75 mm, 80 mm, 85 mm, 90 mm or any range formed by any of these values or possibly larger or smaller.

The microscope objective 12 provides sufficient and net positive optical power via the combination of positive lenses and negative lenses to focus the light from the laser 16. Lower magnification, however, can provide for an increased field size (as a result of a longer focal length) and/or facilitate the design of increased working distance 40.

Designed provided herein reduces aberration and provides diffraction limited performance for at least a wavelength or wavelength band of light such as a NIR wavelength band (e.g., 910-920 nm, 920-930 nm, 910-930 nm, 1040-1050 nm, 1050-1060 nm, 1040-1060 nm, or any combination of these). The wavelengths over which the microscope object is diffraction limited, however, may be larger or smaller. Additionally, the microscope objective 12 may be designed for and/or have diffraction limited performance for other wavelengths. As discussed above, this design wavelength of light may correspond to the wavelength of the laser beam 18 such that a small spot size may be formed at the focus 33 of the microscope objective 12. Such small spot size may provide for increased resolution of the image produced by the scanning laser microscope 10.

The microscope objective 12 shown in FIG. 2 includes a first stage 44 comprising a first diverging lens or lens element 46 having negative optical power. Consequently, collimated light (e.g., collimated laser beam 18f) incident on the diverging lens element 46 is caused by the diverging lens to diverge as the light propagates away from the diverging lens in the direction toward the distal end 15 of the microscope objective 12. See, for example, diverging rays 48.

The diverging lens or lens element 46 includes first and second surfaces (optical surfaces) 50, 52. The first optical surface 50 is concave and provides sufficient optical power to cause the light incident thereon 18f to diverge within the body of the diverging lens 46. This surface 50 has a high curvature. Moreover, this first optical surface 50, the most proximal optical surface of the microscope objective 12, also has the highest curvature of all the lenses in the microscope objective 12. In this example, the curvature is 1/15 mm⁻¹. See for example the tables in FIGS. 3A and 3B. Other curvatures, however, are possible, such as ⅛ mm⁻¹, 1/10 mm⁻¹, 1/12 mm⁻¹, 1/14 mm⁻¹, 1/16 mm⁻¹, 1/20 mm⁻¹, 1/25 mm⁻¹, 1/30 mm⁻¹, 1/35 mm⁻¹, 1/40 mm⁻¹, 1/50 mm⁻¹ or in any range formed by any of these values or possibly larger or smaller curvatures. The diverging lens or lens element 46 is relatively thick, having a thickness of more than 9 mm in this case. Other thicknesses may be employed, for example, the thickness in the longitudinal direction (Z direction), e.g., along the optical axis, may be 5 mm, 6 mm, 7 mm, 8 mm, 9 mm, 10 mm, 11 mm, 12 mm or in any range formed by any of these values or possibly larger or smaller thicknesses.

The second optical surface 52 is also curved and is a concave optical surface. Accordingly, the diverging lens 46 is a bi-concave lens in this example. The curvature of this second optical surface 52, however, is much less than the curvature of the first optical surface 50. In this example, the curvature is 1/79 mm⁻¹. The curvature of the second optical surface 52, however, can be different. The curvature may, for example be 1/50 mm⁻¹, 1/55 mm⁻¹, 1/60 mm⁻¹, 1/65 mm⁻¹, 1/70 mm⁻¹, 1/75 mm⁻¹, 1/78 mm⁻¹, 1/80 mm⁻¹, 1/85 mm⁻¹, 1/90 mm⁻¹, 1/95 mm⁻¹, 1/100 mm⁻¹, 1/110 mm⁻¹, 1/120 mm⁻¹, 1/150 mm⁻¹, 1/200 mm⁻¹, 1/250 mm⁻¹, 1/400 mm⁻¹, 1/600 mm⁻¹, 1/800 mm⁻¹, 1/800 mm⁻¹ or in any range formed by any of these values or may be larger or smaller.

The diverging lens or lens element 46 shown in the example of FIG. 2 has a fairly large clear aperture, e.g., greater than 36 mm in lateral extent (e.g., diameter). The clear aperture of the second optical surface 52, for example, is greater 40 mm in lateral extent (e.g., diameter). Thus, the diverging lens 50 may have a clear aperture of greater than 34 mm, 35 mm, 37 mm, 38 mm, 39 mm, 40 mm, 42 mm, 44 mm or a clear aperture in any range formed by any of these values or possible larger or smaller. The mechanical size may be any of these values or ranges or possibly larger, e.g., 42 mm, 43 mm, 44 mm, 45 mm, or in any range formed by any of these or possible larger or smaller.

The clear aperture of the first optical surface 50 is smaller, 26 mm in the example. The clear aperture of the first optical surface 50, however, may be smaller or larger. The clear aperture of the first optical surface 50 may, for example, be 22 mm, 24 mm, 25 mm, 27 mm, 28 mm, 30 mm, 32 mm, 34 mm, 35 mm or a clear aperture in any range formed by any of these values or possible larger or smaller. The clear aperture of the second optical surface 52 may be 34 mm, 35 mm, 37 mm, 38 mm, 39 mm, 40 mm, 42 mm, 44 mm, 46 mm or a clear aperture in any range formed by any of these values or possible larger or smaller.

Potentially in some designs the diverging lens or lens element 46 of stage 1 may be split into two lenses or lens elements with the more proximal of these lenses or lens elements being smaller in clear aperture size as the clear aperture of the first optical surface is 26 mm. Likewise, the clear aperture may be reduced below 34 mm, 36 mm or 38 mm and may be 22 mm, 23 mm, 24 mm, 25 mm, 27 mm, 28 mm, 29 mm, 30 mm, 31 mm, 32 mm, 33 mm, 35 mm or in any range formed by any of these values or possibly larger or smaller.

In the example microscope objective 12 shown in FIG. 2, the first stage 44 further includes a second lens or lens element 54 having positive optical power. The second lens or lens element 54 in the first stage 44 has first and second (proximal and distal) optical surfaces 56, 58. In the example shown, the second optical surface (distal surface) 58 is convex and has a higher curvature than the first optical surface 56. The second optical surface 58, for example, has a curvature of 1/28 mm⁻¹, however, the curvature can be different. The curvature of the second optical surface 58, for example, can be 1/20 mm⁻¹, 1/25 mm⁻¹, 1/27 mm⁻¹, 1/30 mm⁻¹, 1/35 mm⁻¹, 1/40 mm⁻¹, 1/50 mm⁻¹, 1/60 mm⁻¹, 1/70 mm⁻¹, 1/80 mm⁻¹, 1/90 mm⁻¹ or 1/100 mm⁻¹ or in any range formed by any of these values or possibly larger or smaller. As a result of the high curvature of the second optical surface 58, the diverging light 48 is refracted so as to be less divergent and more collimated as illustrated by ray 60. As a consequence, the first stage 44 comprising the first and second lenses 46 and 54 effectively operates as a beam expander, increasing the diameter of the input collimated beam and outputting a larger diameter beam that is almost collimated. In some implementations, the beam exiting the second surface 58 may be collimated.

The first (proximal) optical surface 56 of the second lens or lens element 54 is also convex. Although the first optical surface 56 has less curvature than the second (distal) optical surface 58 in the example shown in FIG. 2, the curvature of the first surface 56 is non-negligible. The first optical surface 56, for example, has a curvature of 1/79 mm⁻¹. The curvature of the first optical surface 56, however, may be different. The first optical surface 56 may, for example, have a curvature of 1/50 mm⁻¹, 1/60 mm⁻¹, 1/70 mm⁻¹, 1/75 mm⁻¹, 1/78 mm⁻¹, 1/80 mm⁻¹, 1/85 mm⁻¹, 1/90 mm⁻¹, 1/100 mm⁻¹, 1/110 mm⁻¹, 1/120 mm⁻¹, 1/130 mm⁻¹, 1/140 mm⁻¹, 1/150 mm⁻¹, 1/160 mm⁻¹, 1/170 mm⁻¹, 1/180 mm⁻¹, 1/190 mm⁻¹, 1/200 mm⁻¹ or may be in any range formed by any of these values or may possibly be larger or smaller.

As shown, in various implementations the second lens 54 in the second stage 44 is bi-convex. The thickness of the second lens or lens element 54 shown in FIG. 2 is 17.9 mm. This second lens element 54 is the thickest lens element in the microscope objective 12 shown in FIG. 2. The thickness, however, may be different. The thickness of the second lens or lens element 54 in the longitudinal direction (Z direction), e.g., along the optical axis, may, for example, be 9 mm, 10 mm, 11 mm, 12 mm, 13 mm, 14 mm, 15 mm, 16 mm, 17 mm, 18 mm, 20 mm, 21 mm, 22 mm or in any range formed by any of these values, or possibly larger or smaller.

The clear optical aperture of the second lens or lens element 54 is about 44 mm. The clear aperture of the second (distal) optical surface on the second lens 54 is also about 46 mm. However, either or both may be different. For example, either or both the clear aperture of the second lens 54 or the second (distal) optical surface on the second lens may be 32 mm, 34 mm, 35 mm, 37 mm, 38 mm, 39 mm, 40 mm, 41 mm, 42 mm, 43 mm, 44 mm, 45 mm, 46 mm, 47 mm 48 mm, 49 mm, 50 mm, or in any range formed by any of these values or possibly larger or smaller. The clear aperture of the first (proximal) optical surface 56 on the second lens or lens element 54 is also about 40 mm. The clear aperture of the first (proximal) optical surface 56 on the second lens, however, may be 34 mm, 35 mm, 37 mm, 38 mm, 39 mm, 40 mm, 42 mm, 44 mm, 46 mm or a clear aperture in any range formed by any of these values or possible larger or smaller.

In the example shown in FIG. 2, the first and second (proximal and distal) lenses or lens elements 46, 54 in the first stage 44 form a doublet. The first and second (proximal and distal) lenses or lens elements 46, 54 are in contact and/or are adhered together, for example, using cement, adhesive, epoxy or other bonding technique. In particular, the second surface 52 of the first lens or lens element 46 is in contact with and/or adhered to the first surface 56 of the second lens or lens element 54. The thickness of the doublet shown in FIG. 2 is 27 mm, however the thickness may be different. The thickness of the doublet as measured, for example, along the optical axis therethrough or in the longitudinal direction or Z direction, may be 20 mm, 22 mm, 24 mm, 26 mm, 28 mm, 30 mm, 32 mm, 34 mm or in any range formed by any of these values or possibly larger or smaller. In other implementations, however, a gap may separate the first and second lens 46, 54 of the first stage 44 and/or second surface 52 of the first lens and the first surface 56 of the second lens. In various implements, the combination of the first and second lenses or lens elements 46, 54 has net negative power, although the amount of net optical power may be relatively small. As discussed above, however, the first and second lenses or lens elements 46, 54 of the first stage 44 may operate as a beam expanding element. This doublet is expanding the beam size (or the ray height relative to the optical axis), so that the marginal rays have enough height to get focused by the lens 100 later and support the large working distance. In the example shown, the collimated laser beam 18f input into the first lens or lens element 46 is output the second lens or lens element 54 larger in beam lateral spatial extent or diameter (e.g., beam cross-section) almost collimated in this example however depending on the design, the beam need not be collimated or almost collimated but in some implementations may be collimated.

The microscope objective 12 shown in FIG. 2 further comprises a second stage 62. The second stage 62 is more distal than the first stage 44. The second stage 62 comprises a positive lens or lens element 64 having a first (proximal) optical surface 66 and a second (distal) optical surface 68. In the example shown, both the first and second optical surfaces 64, 66 are convex. Accordingly, the positive lens or lens element 64 in the second stage is a bi-convex lens in the example shown.

The positive lens or lens element 64 in the second stage 62 is configured to receive the diverging or possibly collimated or almost collimated beam 60 and to cause the light to begin to converge from the widest lateral extent of the beam in the microscope objective 12. FIG. 2 shows this light being refracted by the positive lens or lens element 64 in the second stage 62 and beginning to converge as illustrated by rays 70 within the positive lens and rays 72 output by the positive lens.

The first (proximal) optical surface 66 of positive lens or lens element 64 in second stage 62 has more curvature than the second (distal) optical surface 68, however, the curvatures may be different. The curvature of the first optical surface 66, for example, is 1/82.8 mm⁻¹ while the second surface 68 is 1/162 mm⁻¹. The curvatures may be different, and the curvature of the second optical surface 68 may be larger than the curvature of the first optical surface 66 in some implementation. For example, the curvature of the first optical surface 66 may be 1/50 mm⁻¹, 1/60 mm⁻¹, 1/70 mm⁻¹, 1/80 mm⁻¹, 1/90 mm⁻¹, 1/100 mm⁻¹, 1/110 mm⁻¹, 1/120 mm⁻¹, 1/130 mm⁻¹, 1/140 mm⁻¹, 1/150 mm⁻¹, 1/160 mm⁻¹, 1/170 mm⁻¹, 1/180 mm⁻¹, or in any range between any of the values or possibly larger or smaller. The curvature of the second optical surface 68 may be 1/90 mm⁻¹, 1/100 mm⁻¹, 1/110 mm⁻¹, 1/120 mm⁻¹, 1/130 mm⁻¹, 1/140 mm⁻¹, 1/150 mm⁻¹, 1/160 mm⁻¹, 1/170 mm⁻¹, 1/180 mm⁻¹, 1/190 mm⁻¹, 1/200 mm⁻¹, 1/250 mm⁻¹, 1/300 mm⁻¹ or in any range between any of the values or possibly larger or smaller.

In the example shown in FIG. 2, the second stage 62 is separated from the first stage 44 by 10.3 mm, however, the distance separating the two stages may be different. For example, the first and second stages 44, 62 may be separated by a longitudinal distance (in Z direction), e.g., along the optical axis, of 6 mm, 7 mm, 8 mm, 9 mm, 10 mm, 11 mm, 12 mm, 13 mm, 14 mm, 15 mm or in any range formed by any of these values or possibly larger or smaller distances.

In various implementations, however, the lens 64 in the second stage 62 can move. As referenced above, for example, the housing 11 may include a rotatable collar 42. The lens or lens element 64 may be configured to translate in the longitudinal direction (Z direction), e.g., along the optical axis, when the collar 42 is rotated. In various designs, for example, adjustment of from 0 to 1 or 0 to 2 mm can be made. Adjustment to accommodate a cover slip of from 0-0.35 mm can also be made. Other configurations for translating the lens 64 in the second stage 62 are possible. Moving the lens or lens element 64 in the second stage 62 may change the focal plane and be used compensate or reduce spherical aberration caused by the refractive index change from the air-to-glass-to-sample interfaces and the thickness of these different materials.

In the example shown, the air gap between the singlet 62 and the triplet 74 is changed to by adjusting the correction collar. In this example design, the doublet comprising the lens elements 46, 54 in the first stage 44 and the singlet 64 in the second stage 62 are configured to move together (e.g. the air gap between the double and the singlet remains unchanged). The air gap between the triplet 75 and the meniscus 100 also remains unchanged. In alternative designs, the correction collar can be designed so that only the singlet 64 is moving, and both the airgaps before it and after it vary, while other lens elements are stationary.

As discussed above, the positive lens or lens element 64 in the second stage 62 is configured to receive the diverging or possibly collimated beam 60 and to cause the light to begin to converge from the widest lateral extent of the beam in the microscope objective 12. Accordingly, the lens or lens element 64 in the second stage 62 has a large clear aperture. In the example shown in FIG. 2, the clear aperture (e.g., diameter) of the lens or lens element 64 is 46.8 mm, however, the lens may have a different lateral spatial extent (e.g., in X and/or Y directions). The clear aperture may, for example, be 34 mm, 36 mm, 38 mm, 39 mm, 40 mm, 42 mm, 44 mm, 45 mm, 47 mm, 48 mm, 50 mm, 52 mm or in any range formed by any of the values or may possibly be larger or smaller.

In the example shown in FIG. 2, the clear aperture (e.g., diameter) of the first optical surface 66 of the lens 64 is 46.8 mm, however, the lens may have a different lateral spatial extent (e.g., in X and/or Y directions). The clear aperture may, for example, be 34 mm, 36 mm, 38 mm, 39 mm, 40 mm, 42 mm, 44 mm, 45 mm, 47 mm, 48 mm, 50 mm, 52 mm or in any range formed by any of the values or may possibly be larger or smaller. The clear aperture (e.g., diameter) of the second optical surface 66 of the lens 64 is 45 mm, however, the lens may have a different lateral spatial extent (e.g., in X and/or Y directions). The clear aperture may, for example, be 33 mm, 35 mm, 37 mm, 38 mm, 39 mm, 41 mm, 43 mm, 44 mm, 46 mm, 47 mm, 49 mm, 51 mm or in any range formed by any of the values or may possibly be larger or smaller.

The lens or lens element 64 in the second stage 62 has a thickness of 12 mm in the example shown in FIG. 2. This thickness, however, may be different. The thickness of the lens 64 along the optical axis and/or in the longitudinal (e.g., Z) direction may be 7 mm, 8 mm, 9 mm, 10 mm, 11 mm, 13 mm, 14 mm, 15 mm or in any range formed by any of these values or possibly larger or smaller.

As illustrated, in some implementations, the second stage 62 includes a single lens or lens element 64. In other designs, however, more than a single lens or lens element may be included in the second stage.

The microscope objective 12 further comprises a third stage 74. The third stage 74 is more distal than the second stage. The third stage 74 comprises a triplet 75. Accordingly, the positive lens or lens element 64 in the second stage 62 is between the diverging lens or lens element 46 in the first stage 44 and the triplet 75 in the third stage 74. The triplet 75 comprises three lenses: a first positive lens or lens element 76, a second negative lens or lens element 78, and a third positive lens or lens element 80. The second negative or lens element lens 78 is in the optical path between the first and third positive lenses 76, 80. The triplet 75 is configured to reduce chromatic aberration of the microscope objective 12 by compensating for chromatic aberration in the first, second, fourth stages or any combination thereof. The triplet 75 may, for example, provide chromatic aberration to compensate for or offset chromatic compensation in the first, second and fourth stages for a wavelength of the light 18 output by the laser source 16. Accordingly, in various designs, the triplet 75 provides compensating color correction to offset at least some (possibly most) chromatic aberration of other lenses in the microscope objective 12, for example, in the first, second, or fourth stages or any combinate thereof (e.g., each of first, second and fourth stages) at 910 nm, 920 nm, 930 nm, 1040 nm, 1050 nm, 1060 nm or any range formed by any of these values such as, e.g., 910-930 nm and/or 1040-1060 nm, or possibly other wavelengths, larger or smaller or longer or shorter.

The first lens or lens element 76 in the triplet 75 has first (proximal) and second (distal) optical surfaces 82, 84. In the example shown in FIG. 2, both the first and second optical surfaces 82, 84 of the first lens or lens element 76 are curved and, in particular, have convex curvature. Accordingly, in the example, the first lens or lens element 76 is a bi-convex lens. In the example shown, the distal surface 84 has a little more curvature than the proximal surface 82 although both surfaces are similar in curvature. In particular, the first (proximal) optical surface 82 has a curvature of 1/60.6 mm⁻¹ while the second (distal) optical surface 84 has a curvature of 1/49 mm⁻¹. However, the curvatures of the proximal and distal optical surfaces 82, 84 may be different and the second surface need not be more curved than the first surface in certain designs. The first (proximal) optical surface 82 may, for example, have a curvature of 1/35 mm⁻¹, 1/40 mm⁻¹, 1/45 mm⁻¹, 1/50 mm⁻¹, 1/55 mm⁻¹, 1/55 mm⁻¹, 1/65 mm⁻¹, 1/70 mm⁻¹, 1/80 mm⁻¹, 1/90 mm⁻¹, 1/100 mm⁻¹, 1/110 mm⁻¹, 1/120 mm⁻¹, 1/130 mm⁻¹, 1/140 mm⁻¹, 1/150 mm⁻¹, 1/160 mm⁻¹, 1/170 mm⁻¹, 1/180 mm⁻¹, 1/190 mm⁻¹, 1/200 mm⁻¹ or in any range formed by any of these values or possibly larger or smaller. The second (distal) optical surface 84 may, for example, also have a curvature of 1/35 mm⁻¹, 1/40 mm⁻¹, 1/45 mm⁻¹, 1/50 mm⁻¹, 1/55 mm⁻¹, 1/55 mm⁻¹, 1/65 mm⁻¹, 1/70 mm⁻¹, 1/80 mm⁻¹, 1/90 mm⁻¹, 1/100 mm⁻¹, 1/110 mm⁻¹, 1/120 mm⁻¹, 1/130 mm⁻¹, 1/140 mm⁻¹, 1/150 mm⁻¹, 1/160 mm⁻¹, 1/170 mm⁻¹, 1/180 mm⁻¹, 1/190 mm⁻¹, 1/200 mm⁻¹ or in any range formed by any of these values or possibly larger or smaller.

The second lens or lens element 78 in the triplet 75 has first (proximal) and second (distal) optical surfaces 86, 88. In the example shown in FIG. 2, both the first and second surface 86, 88, of the second lens or lens element 78 are curved and, in particular, have concave curvatures. Accordingly, in the example, the second lens or lens element 78 is a bi-concave lens or lens element. In the example shown, the distal optical surface 88 has a little more curvature than the proximal surface 86 although both surfaces are similar in curvature. In particular, the first (proximal) optical surface 82 has a curvature of 1/49 mm⁻¹ while the second optical surface 84 has a curvature of 1/28 mm⁻¹. However, the curvatures of the proximal and distal optical surfaces 86, 88 may be different and the second optical surface need not be more curved than the first optical surface in certain designs. The first (proximal) optical surface 86 may, for example, have a curvature of 1/25 mm⁻¹, 1/30 mm⁻¹, 1/35 mm⁻¹, 1/40 mm⁻¹, 1/45 mm⁻¹, 1/46 mm⁻¹, 1/48 mm⁻¹, 1/50 mm⁻¹, 1/55 mm⁻¹, 1/55 mm⁻¹, 1/65 mm⁻¹, 1/70 mm⁻¹, 1/80 mm⁻¹, 1/90 mm⁻¹, 1/100 mm⁻¹, 1/110 mm⁻¹, 1/120 mm⁻¹, or be in any range formed by any of these values or possibly larger or smaller. The second (distal) surface 88 may, for example, also have a curvature of 1/10 mm⁻¹, 1/15 mm⁻¹, 1/20 mm⁻¹, 1/25 mm⁻¹, 1/27 mm⁻¹, 1/30 mm⁻¹, 1/35 mm⁻¹, 1/40 mm⁻¹, 1/45 mm⁻¹, 1/50 mm⁻¹, 1/55 mm⁻¹, 1/55 mm⁻¹, 1/65 mm⁻¹, 1/70 mm⁻¹, 1/80 mm⁻¹, 1/90 mm⁻¹, 1/100 mm⁻¹, 1/110 mm⁻¹, 1/120 mm⁻¹ or in any range formed by any of these values or possibly larger or smaller.

The third lens or lens element 80 in the triplet 75 has first (proximal) and second (distal) optical surfaces 90, 92. In the example shown in FIG. 2, both the first and second optical surfaces 90, 92 of the third lens or lens element 80 are curved. The first optical surface 90 is convex and the second optical surface 92 is concave. Accordingly, in the example, the third lens or lens element 80 is a meniscus lens or lens element. In the example shown, the proximal surface 90 has a little more curvature than the distal surface 92 although both surfaces are similar in curvature. In particular, the first (proximal) optical surface 90 has a curvature of 1/28 mm⁻¹ while the second optical surface 92 has a curvature of 1/129 mm⁻¹. However, the curvatures of the proximal and distal optical surfaces 90, 92 may be different and the first surface need not be more curved than the second surface in certain designs. The first (proximal) optical surface 90 may, for example, have a curvature of 1/10 mm⁻¹, 1/15 mm⁻¹, 1/20 mm⁻¹, 1/25 mm⁻¹, 1/27 mm⁻¹, 1/30 mm⁻¹, 1/35 mm⁻¹, 1/40 mm⁻¹, 1/45 mm⁻¹, 1/50 mm⁻¹, 1/55 mm⁻¹, 1/55 mm⁻¹, 1/65 mm⁻¹, 1/70 mm⁻¹, 1/80 mm⁻¹, 1/90 mm⁻¹, 1/100 mm⁻¹, 1/110 mm⁻¹, 1/120 mm⁻¹, or a curvature in any range formed by any of these values or possibly larger or smaller. The second (proximal) optical surface 92 may, for example, also have a curvature of 1/60 mm ¹, 1/70 mm⁻¹, 1/80 mm⁻¹, 1/90 mm⁻¹, 1/100 mm⁻¹, 1/110 mm⁻¹, 1/120 mm⁻¹, 1/125 mm⁻¹, 1/130 mm⁻¹, 1/135 mm⁻¹, 1/140 mm⁻¹, 1/145 mm⁻¹, 1/150 mm⁻¹, 1/160 mm⁻¹, 1/170 mm⁻¹, 1/180 mm⁻¹, or in any range formed by any of these values or possibly larger or smaller.

The triplet 75 in the third stage 74 is configured to receive the converging light 72 and allows the light to continue to converge within the microscope objective 12. See rays 94, 96, 97 propagating through the first, second and third lenses or lens elements 76,78, 80, respectively, of the triplet 75. The light 78 exiting the triplet 75 continues to converge, possibly not at as steep a rate or slope as the light 72 incident on the triplet. Although, in various implementations, the triplet 75 has negative power and/or negligible optical power, the triplet could have positive power.

As discussed above, the combination of the first, second, and third lenses or lens elements 76, 78, 80 in the triplet 75 are configured to reduce chromatic aberration introduced by the other lenses in the microscope objective 12. In various designs, the effects of wavelength dispersion of second negative lens or lens element 78 is configured to offset the effects of wavelength dispersion of the first and third positive lenses or lens elements 76, 80 in the triplet 75. The second negative lens or lens element 78 also has a smaller abbe number (e.g., almost half as much as the third lens or lens element 80 in the triplet 75 and almost four times as much as the first lens or lens element 76 in the triplet), which means the second (negative) lens has higher wavelength dispersion. The Abbe numbers (V-number) for the first, second, and third lenses or lens elements 76, 78, 80 are 67.7, 17.5, and 32.3, respectively. Likewise, in various implementations the Abbe number of the third lens 80 may be as much as 1.5 times, 1.6 times, 1.7 times, 1.8 times, 1.9 times, 2.0 times, 2.1 times, 2.2 times, the Abbe number of the second lens 78 or in any range formed by any of these values or possibly larger or smaller. Moreover, in various implementations the Abbe number of the third lens 80 may be as much as 1.6 times, 1.8 times, 2.0 times, 2.2 times, 2.5 times, 2.8 times, 3.0 times, 3.2 times, 3.5 times, 3.6 times, 3.7 times, 3.8 times, 3.9 times, 4.0 times, 4.1 times, 4.2 times, 4.3 times, 4.4 times, 4.5 times the Abbe number of the second lens 78 or in any range formed by any of these values or possibly larger or smaller.

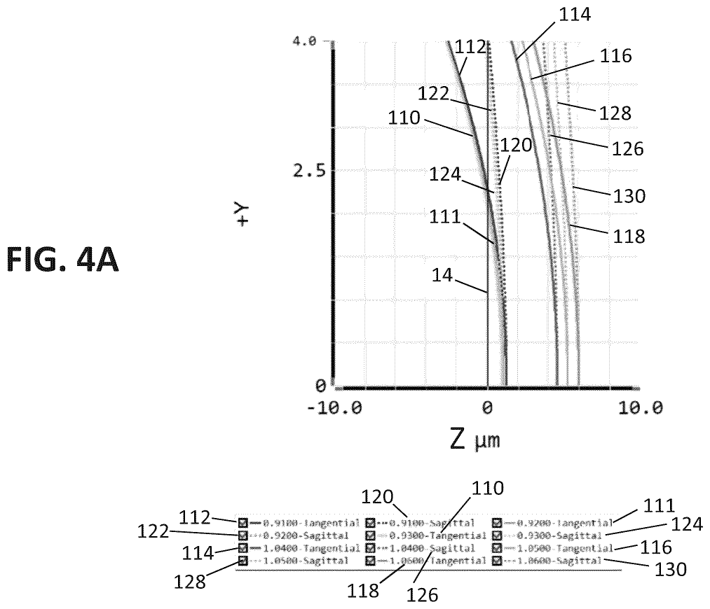

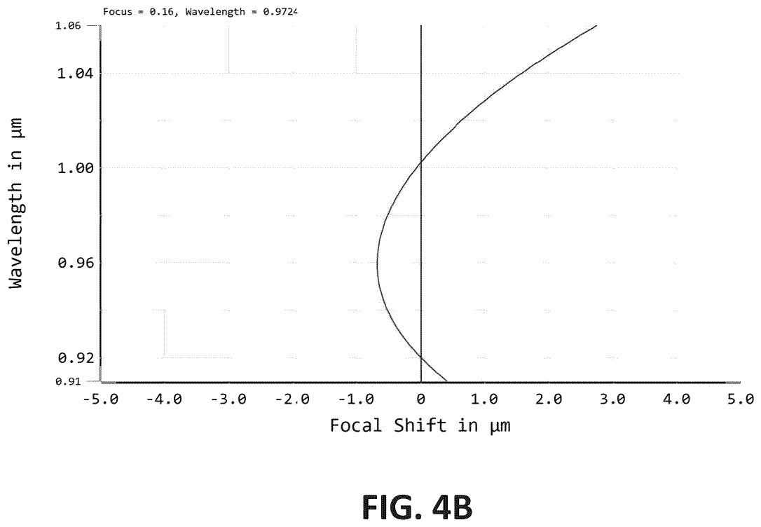

In various implementations, the triplet 75 has chromatic aberration for at least one wavelength, possibly the wavelength or wavelength band of the laser light source 16 and the output laser beam 18 or a portion thereof, that offsets chromatic aberration from the first, second, and fourth stages combined based on the ray tracing analysis. In various implementations, as a result of the reduced chromatic aberration in the microscope objective 12, the microscope objective has a maximum focal shift with wavelength that is 5 microns or less, 4 microns or less, 3 microns or less, 2 microns or less, 1 microns, 0.5 micron, or less, or any range formed by any of these values, or possible larger or smaller, over a range of wavelengths of 50 nm, 75 nm, 100 nm, 125 nm, 150 nm, 175 nm, 200 nm, 250 nm, 300 nm or any range formed by any of these values, or possible larger or smaller, such as at the design wavelength range, e.g., of 910-1060 nm. The plot in FIG. 4B shows the variation in focal length of the microscope objective 12 as a function of wavelength, relative to the primary wavelength of 0.92 micron. The maximum focal shift is less than 4 microns at the design wavelength range, e.g., of 910-1060 nm.

In the example shown in FIG. 2, the third stage 74 is separated from the second stage 62 by 1.6 mm, however, the distance separating the two stages may be different. For example, the second and third stages 62, 74 may be separated by a longitudinal distance (in Z direction), e.g., along the optical axis, of 0.5 mm, 1.0 mm, 1.2 mm, 1.5 mm, 1.6 mm, 1.7 mm, 1.8 mm, 2.0 mm, 2.5 mm, 3 mm, 4 mm, 5 mm, 6 mm, 7 mm, 8 mm or in any range formed by any of these values or possibly larger or smaller. As mentioned above, in various implementations, the first and second stages 44, 62 can translate in the longitudinal direction (Z), e.g., along the optical axis. For example, in the example design shown, the air gap between the second stage 62 and the third stage 74 is changed by moving the doublet comprising lens elements 46, 54 and singlet 64 together relative to the triplet 75 and the meniscus 99 together.

The triplet 75 in the third stage 74 has a large clear aperture. In the example shown in FIG. 2, the clear aperture (e.g., diameter) of the first (proximal) lens or lens element 76 is 41.6 mm, however, the lens or lens element may have a different lateral spatial extent (e.g., in X and/or Y directions). The clear optical aperture (e.g., diameter of the optical surface) may, for example, be 34 mm, 36 mm, 38 mm, 39 mm, 40 mm, 42 mm, 44 mm, 45 mm, 47 mm, 48 mm, 50 mm, 52 mm or in any range formed by any of the values or possibly larger or smaller.

In the example shown in FIG. 2, the clear optical aperture (e.g., diameter) of the second (medial) lens or lens element 78 is 39 mm, however, the lens or lens element may have a different lateral spatial extent (e.g., in X and/or Y directions). The clear optical aperture (e.g., diameter of the optical surface) may, for example, be 30 mm, 32 mm, 34 mm, 36 mm, 38 mm, 39 mm, 40 mm, 42 mm, 44 mm, 45 mm, 47 mm, 48 mm, 50 mm, 52 mm or in any range formed by any of the values.

In the example shown in FIG. 2, the clear optical aperture (e.g., diameter) of the third (distal) or lens element lens 80 is 35 mm, however, the lens or lens element may have a different lateral spatial extent (e.g., in X and/or Y directions). The clear optical aperture (e.g., diameter of the optical surface) may, for example, be 28 mm, 29 mm, 30 mm, 32 mm, 34 mm, 36 mm, 38 mm, 39 mm, 40 mm, 42 mm, 44 mm, 45 mm, 48 mm, 50 mm, or in any range formed by any of the values.

Likewise, the clear aperture of the first (proximal) surface 82 of the first (proximal) lens 76 in the triplet 75 is 41.6 mm, however, this optical surface may have a different lateral spatial extent (e.g., in X and/or Y directions). The clear optical aperture (e.g., diameter of the optical surface) may, for example, be 34 mm, 36 mm, 38 mm, 39 mm, 40 mm, 42 mm, 44 mm, 45 mm, 47 mm, 48 mm, 50 mm, 52 mm, or in any range formed by any of the values. The clear aperture of the second (distal) surface 84 of the first (proximal) lens or lens element 76 in the triplet 75 is 39.2 mm, however, this optical surface may have a different lateral spatial extent (e.g., in X and/or Y directions). The clear optical aperture (e.g., diameter of the optical surface) may, for example, be 30 mm, 32 mm, 34 mm, 36 mm, 38 mm, 39 mm, 40 mm, 42 mm, 44 mm, 45 mm, 47 mm, 48 mm, 50 mm, 52 mm, or in any range formed by any of the values.

The clear aperture of the first (proximal) surface 86 of the second (middle) lens 78 in the triplet 75 is 39.2 mm, however, this optical surface may have a different lateral spatial extent (e.g., in X and/or Y directions). The clear optical aperture (e.g., diameter of the optical surface) may, for example, be 30 mm, 32 mm, 34 mm, 36 mm, 38 mm, 39 mm, 40 mm, 42 mm, 44 mm, 45 mm, 47 mm, 48 mm, 50 mm, 52 mm, or in any range formed by any of the values. The clear aperture of the second (distal) surface 88 of the second (middle) lens 78 in the triplet 75 is 35.3 mm, however, this optical surface may have a different lateral spatial extent (e.g., in X and/or Y directions). The clear optical aperture (e.g., diameter of the optical surface) may, for example, be 28 mm, 29 mm, 30 mm, 32 mm, 34 mm, 36 mm, 38 mm, 39 mm, 40 mm, 42 mm, 44 mm, 45 mm, 48 mm, 50 mm, or in any range formed by any of the values.

The clear aperture of the first (proximal) surface 90 of the third (distal) or lens element lens 80 in the triplet 75 is 35.3 mm, however, this optical surface may have a different lateral spatial extent (e.g., in X and/or Y directions). The clear optical aperture (e.g., diameter of the optical surface) may, for example, be 28 mm, 29 mm, 30 mm, 32 mm, 34 mm, 36 mm, 38 mm, 39 mm, 40 mm, 42 mm, 44 mm, 45 mm, 48 mm, 50 mm, or in any range formed by any of the values. The clear aperture of the second (distal) surface 92 of the third (distal) lens or lens element 80 in the triplet 75 is 34 mm, however, this optical surface may have a different lateral spatial extent (e.g., in X and/or Y directions). The clear optical aperture (e.g., diameter of the optical surface) may, for example, be 27 mm, 28 mm, 29 mm, 30 mm, 32 mm, 34 mm, 36 mm, 38 mm, 39 mm, 40 mm, 42 mm, 44 mm, 45 mm, 48 mm, 50 mm, or in any range formed by any of the values.

The first, second and third lenses or lens elements 76, 78, 80 in triplet 75 have thicknesses of 10.2 mm, 3 mm, and 7.7 mm, respectively, in the example shown in FIG. 2. These thicknesses, however, may be different. The thickness of the first lens or lens element 76 along the optical axis and/or in the longitudinal (e.g., Z) direction may be 7 mm, 8 mm, 9 mm, 10 mm, 11 mm, 13 mm, 14 mm, 15 mm or in any range formed by any of these values or possibly larger or smaller. The thickness of the second lens or lens element 78 along the optical axis and/or in the longitudinal (e.g., Z) direction may be 1.0 mm, 1.5 mm, 2.0 mm, 2.5 mm, 3.1 mm, 3.5 mm, 4.0 mm, 4.5 mm, 5.0 mm, 5.5 mm, 6.0 mm, 6.5 mm or in any range formed by any of these values or possibly larger or smaller. The thickness of the third lens or lens element 30 along the optical axis and/or in the longitudinal (e.g., Z) direction may be 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, 10.0 mm, 10.5 mm, 11.0 mm, 11.5 mm, 12.0 mm or in any range formed by any of these values or possibly larger or smaller.

As illustrated in FIG. 2, first lens or lens element 76 may be in contact with and/or adhered (e.g., with cement, adhesive, epoxy) to the second lens or lens element 78. Similarly, second lens or lens element 78 may be in contact with and/or adhered (e.g., with cement, adhesive, epoxy) to the third lens or lens element 80. Likewise, in various implementations, the first, second, and third lenses or lens elements 76, 78, 80 may form a triplet. However, in other implementations, the first lens or lens element 76 may be separated in the longitudinal (Z) direction from the second lens or lens element 78 and/or the second lens or lens element 78 may be separated in the longitudinal (Z) direction from the third lens or lens element 80, e.g., by a gap.

As illustrated, in some implementations, the third stage 74 includes three lenses or lens elements 76, 78, 80. In other designs, however, more lenses or lens elements may be included in the third stage 74.

The microscope objective 12 further comprises a fourth stage 99 comprising a distal focusing lens or lens element 100. The fourth stage 99 is more distal than the third stage. Accordingly, the triplet 75 in the third stage 74 is between the positive lens or lens element 64 in the second stage 62 and the distal focusing lens or lens element 100 in the fourth stage 99. The distal focusing lens or lens element 100 is configured to focus collimated light 18f incident on the proximal end 13 of the microscope objective 12 onto the sample plane 14. Accordingly, in various implementations, the distal focusing lens or lens element 100 comprises a positive lens. In some designs, the distal focusing lens or lens element 100 is the lens with the highest positive optical power in the microscope objective 12. In some designs, the distal focusing lens or lens element 100 is the lens with the highest optical power in the microscope objective 12.

In the example shown in FIG. 2, the distal focusing lens or lens element 100 in the fourth stage 99 is the lens that is closest to the focus of the microscope objective 12 or image plane 14 where the collimated light incident on the proximal end 13 of the microscope objective will be focused. The distal focusing lens or lens element 100 has first (proximal) and second (distal) optical surfaces 102, 104. In the example shown in FIG. 2, both the first and second optical surfaces 102, 104 of the distal focusing lens or lens element 100 are curved. In particular, the first (proximal) surface 102 has a convex curvature and the second (distal) surface 104 has a concave surface 104. Accordingly, in the example shown, the distal focusing lens or lens element 100 is a meniscus lens. In the example shown, the proximal optical surface 102 has more curvature than the distal optical surface 104 although both surfaces are similar in curvature. In particular, the first (proximal) optical surface 102 has a curvature of 1/20.5 mm⁻¹ while the second optical surface 104 has a curvature of 1/29.9 mm⁻¹. However, the curvatures of the proximal and distal optical surfaces 102, 104 may be different and the first optical surface need not be more curved than the second optical surface in certain designs. The first (proximal) optical surface 102 may, for example, have a curvature of 1/10 m⁻¹, 1/12 mm⁻¹, 1/14 mm⁻¹, 1/15 mm⁻¹, 1/16 mm⁻¹, 1/17 mm⁻¹, 1/18 mm⁻¹, 1/19 mm⁻¹, 1/20 mm⁻¹, 1/21 mm⁻¹, 1/22 mm⁻¹, 1/24 mm⁻¹, 1/26 mm⁻¹, 1/28 mm⁻¹, 1/30 mm⁻¹, 1/32 mm⁻¹, 1/35 mm⁻¹, 1/40 mm⁻¹, 1/50 mm⁻¹, 1/60 mm⁻¹, 1/70 mm⁻¹, 1/80 mm⁻¹, 1/90 mm⁻¹, 1/100 mm⁻¹, or a curvature in any range formed by any of these values or possibly larger or smaller curvatures. The second (distal) surface 104 may, for example, also have a curvature of 1/10 mm⁻¹, 1/12 mm⁻¹, 1/14 mm⁻¹, 1/15 mm⁻¹, 1/16 mm⁻¹, 1/17 mm⁻¹, 1/18 mm⁻¹, 1/19 mm⁻¹, 1/20 mm⁻¹, 1/21 mm⁻¹, 1/22 mm⁻¹, 1/24 mm⁻¹, 1/26 mm⁻¹, 1/28 mm⁻¹, 1/30 mm⁻¹, 1/32 mm⁻¹, 1/35 mm⁻¹, 1/40 mm⁻¹, 1/50 mm⁻¹, 1/60 mm⁻¹, 1/70 mm⁻¹, 1/80 mm⁻¹, 1/90 mm⁻¹, 1/100 mm⁻¹, 1/110 mm⁻¹, 1/120 mm⁻¹, or a curvature in any range formed by any of these values or possibly larger or smaller curvatures.

As discussed above, the distal focusing lens 100 in the fourth stage 99 is configured to receive the converging light 98 from the third stage 74, e.g., from the triplet 75, and to focus the light down onto the sample plane or focal plane 14. See ray 106 propagating through the distal focusing lens 100 and at a steeper slope than the light 98 incident on the proximal surface 102 of the distal focusing lens. The light 108 exiting the distal focusing lens 100 continues to converge and at an even steeper slope as the light is incident on the sample plane or focal plane 14. In this example, the sample plane or focal plane 14 is about 8 to 14 mm (e.g. 12 mm) from the distal end 15 of the microscope objective 12. Accordingly, in various implementations, the distal focusing lens 100 has positive power and potentially a significant amount of positive power.

In the example shown in FIG. 2, the fourth stage 99 is separated from the third stage 74 by 0.5 mm, however, the distance separating the two stages may be different. For example, the third and fourth stages 74, 99 may be separated by a longitudinal distance (in Z direction), e.g., along the optical axis, of 0.1 mm, 0.2 mm, 0.3 mm, 0.4 mm, 0.5 mm, 0.6 mm, 0.7 mm, 0.8 mm, 0.9 mm, 1.0 mm, 1.5 mm, 1.8 mm, 2.0 mm, 2.5 mm, 3 mm, 4 mm, 5 mm, 6 mm, 7 mm, 8 mm or in any range formed by any of these values or possibly larger or smaller.

The distal focusing lens 100 in the fourth stage 99 has a smaller clear aperture than other lenses in the microscope objective 12. In the example shown in FIG. 2, the clear aperture (e.g., diameter of the optical surface) of the distal focusing lens 100 is 32.3 mm, however, the lens may have a different lateral spatial extent (e.g., in X and/or Y directions). The clear optical aperture (e.g., diameter of the optical surface) may, for example, be 28 mm, 29 mm, 30 mm, 31 mm, 32 mm, 33 mm, 34 mm, 35 mm, 36 mm, 38 mm, 40 mm, 42 mm or in any range formed by any of the values or possibly larger or smaller. In some designs, the distal focusing lens 100 may be the smallest lenses (e.g., have the smallest clear aperture) in the microscope objective 12. In other possible designs, the distal focusing lens 100 may be the second smallest lens (e.g., have the second smallest clear aperture) in the microscope objective 12. In some such designs, for example, the proximal most lens 46 in the first stage 44 may have a smaller clear optical aperture.

The clear aperture of the first (proximal) surface 102 of the distal focusing lens 100 in the fourth stage 99 is 32.3 mm, however, this optical surface may have a different lateral spatial extent (e.g., in X and/or Y directions). The clear optical aperture (e.g., diameter of the optical surface) may, for example, be 25 mm, 26 mm, 27 mm, 28 mm, 29 mm, 30 mm, 32 mm, 34 mm, 36 mm, 38 mm, 39 mm, 40 mm, 42 mm, 44 mm, 45 mm, 48 mm, 50 mm, or in any range formed by any of the values. The clear aperture of the second (distal) surface 104 of the distal focusing lens 100 in the fourth stage 99 is 21.7 mm, however, this optical surface may have a different lateral spatial extent (e.g., in X and/or Y directions). The clear optical aperture (e.g., diameter of the optical surface) may, for example, be 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, or in any range formed by any of the values.

The distal focusing lens 100 in the fourth stage 99 has a thickness of 15.1 mm in the example shown in FIG. 2. This thickness, however, may be different. The thickness of the distal focusing lens 100 along the optical axis and/or in the longitudinal (e.g., Z) direction may be 10 mm, 12 mm, 14 mm, 15 mm, 16 mm, 18 mm, 20 mm, 22 mm or in any range formed by any of these values or possibly larger or smaller.

As illustrated, in some implementations, the fourth stage 99 includes a single lenses or lens elements 99. In other designs, however, more lenses or lens elements may be included in the fourth stage 99. For example, the distal focusing lens 100 may be split into two or more lenses or lens elements. This focusing lens 100 may, for example, be split into two or more lenses (e.g., comprise two separate singlets or a cemented doublet).

In various implementations, one or more of the lenses include an anti-reflective (AR) coating thereon. The AR coating may, for example, be for the visible wavelength band and/or infrared or NIR such as 800 nm to 1350 nm or any portion(s) thereof, however, other ranges are possible.

As discussed above, the microscope objective 12 can be designed for different wavelengths. Some designs are configured to have reduced aberration (wavefront aberration and/or chromatic aberration) for 910 nm, 920 nm, 930 nm, 1040 nm, 1050 nm, 1060 nm or any combination of these and/or any range formed by any of these values. For example, the microscope objective 12 may have diffraction limited performance in at least the range of wavelengths from 910 nm to 1060 nm.

Accordingly, plots showing the performance at these wavelengths are provided in FIGS. 4A-4B, 5A-5B, and 6A-6B. These plots are obtained by simulating a microscope objective 12 such as illustrated in FIG. 2 having the prescription set forth in the tables in FIGS. 3A and 3B.

FIG. 4A shows the image fields of the microscope objective 12 for various wavelengths and demonstrates that chromatic aberration is sufficiently reduced. Plots, on axis of lateral field position (in the Y direction) measured by angle (in degrees) versus longitudinal position (Z), show where light comes to focus proximal to the image plane 14. Notably, the image fields where the laser light 18 will come to focus for the 910 nm, 920 nm and 930 nm wavelengths are within 0.5 microns of each other and likely closer, demonstrating corrected chromatic aberration at least for these wavelengths and presumably within the wavelength range from 910 to 930 nm. The image fields where the laser light 18 will come to focus for the 1040 nm, 1050 nm and 1060 nm wavelengths are within about 2 microns of each other, which is acceptable as well. Field curvature is exhibited by the plots. As a reference, a planar image field 14 is shown at the origin. The focus at about 4.0° off axis in the image field is offset along the longitudinal direction (parallel to the Z-axis, e.g., optical axis) by about 4 micrometers (microns, μm) with respect to on-axis for the 910 nm, 920 nm and 930 nm wavelengths. For the 1040 nm, 1050 nm and 1060 nm wavelengths, the focus at about 4.0° off axis in the image field is offset along the longitudinal direction (parallel to the Z-axis, e.g., optical axis) by about 3 microns with respect to on-axis. At 4.0° off axis, the sagittal plane and tangential planes also come to focus at different locations, but within about 3 microns of each other for the 910 nm, 920 nm and 930 nm wavelengths and within about 2-3 microns for the 1040 nm, 1050 nm and 1060 nm wavelengths. Moreover, the image fields, at least out to 4°, where the 1040 nm, 1050 nm and 1060 nm wavelengths come to focus are within about 5-6 micrometers (microns, μm) of the image fields where 910 nm, 920 nm and 930 nm wavelengths come to focus. This performance is an indication of an acceptable level of chromatic aberration correction both on axis and 4.0° off-axis.

As discussed above, FIG. 4B is a plot of the variation in focal length as a function of wavelength or chromatic focal shift, relative to the primary wavelength of 0.92 micron. This plot depicts the chromatic focal shift in the range of 910 nm-1060 nm. The maximum focal shift, for example, is less than 4 microns at the design wavelength range, e.g., of 910-1060 nm. Accordingly, in various implementations, the maximum focal shift with wavelength is 5 microns or less, 4 microns or less, 3 microns or less, 2 microns or less, 1 microns or less, or any range formed by any of these values, or possible larger or smaller, over a range of wavelengths of 50 nm, 75 nm, 100 nm, 125 nm, 150 nm, 175 nm, 200 nm, or any range formed by any of these values, or possible larger or smaller, such as at the design wavelength range, e.g., of 910-1060 nm.

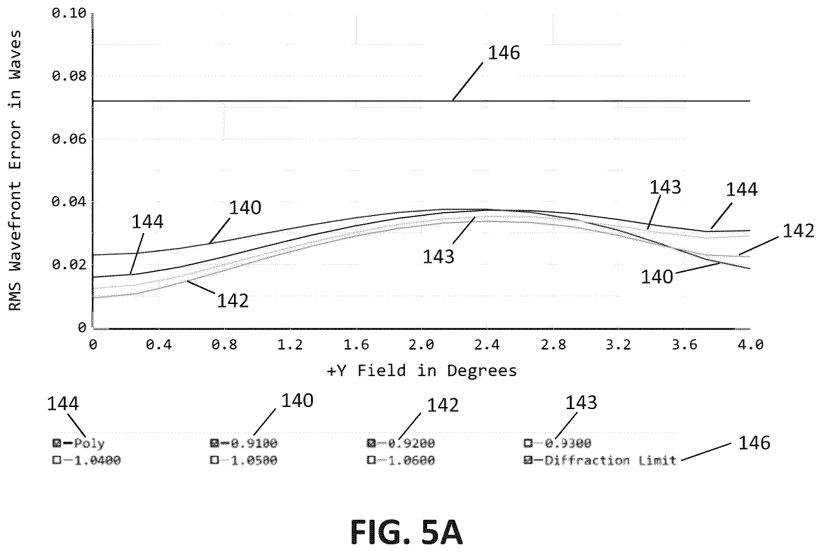

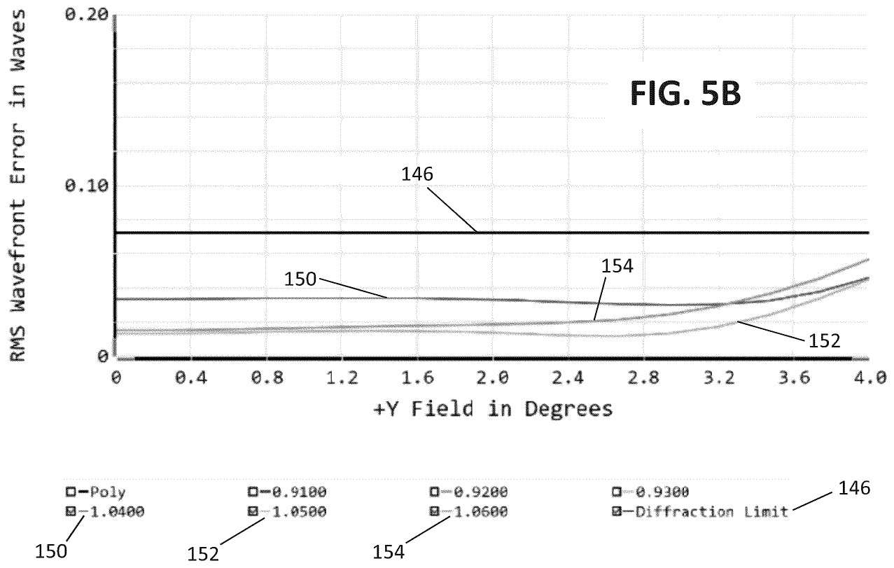

FIGS. 5A and 5B are plots of RMS wavefront error (in waves) across a 4° field for the microscope objective 12 illustrated in FIG. 2 and having the prescription set forth in the tables in FIGS. 3A and 3B. These plots show diffraction limited performance at least across this 4° field. The amount of diffraction limited wavefront error for the microscope objective 12 having the aperture sizes indicated in the tables in FIGS. 3A and 3B is depicted by the horizontal line 146 in FIGS. 5A and 5B. The RMS wavefront error for wavelengths 910 nm (140), 920 nm (142) and 930 (143) as well as for polychromatic light (144) that includes 910 nm and 920 nm, and 930 nm out to a 4° field are shown in FIG. 5A below this diffraction limit, for example, below 0.04 waves. Similarly, the RMS wavefront error for wavelengths 1040 nm (150), 1050 nm (152) and 1060 nm (154) out to a 4° field are shown in FIG. 5B below this diffraction limit 146, for example, below 0.06 waves.

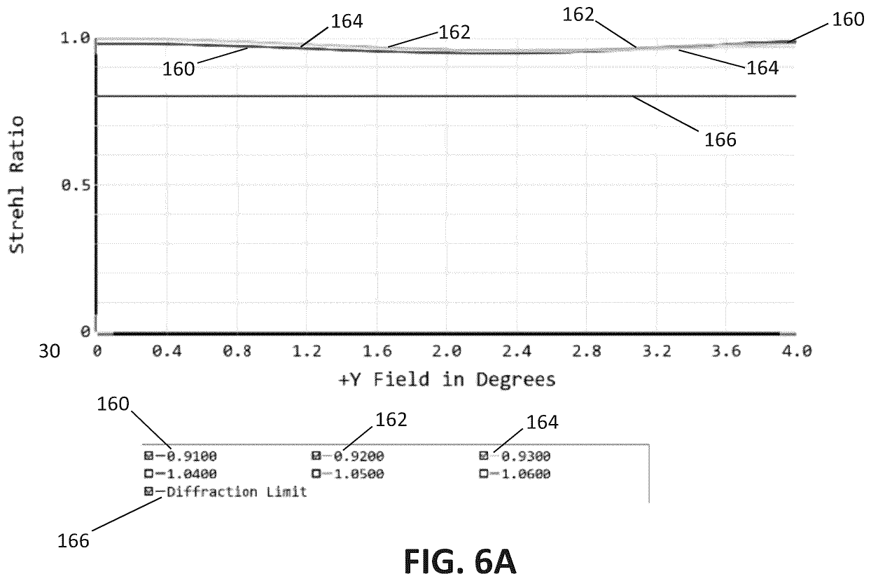

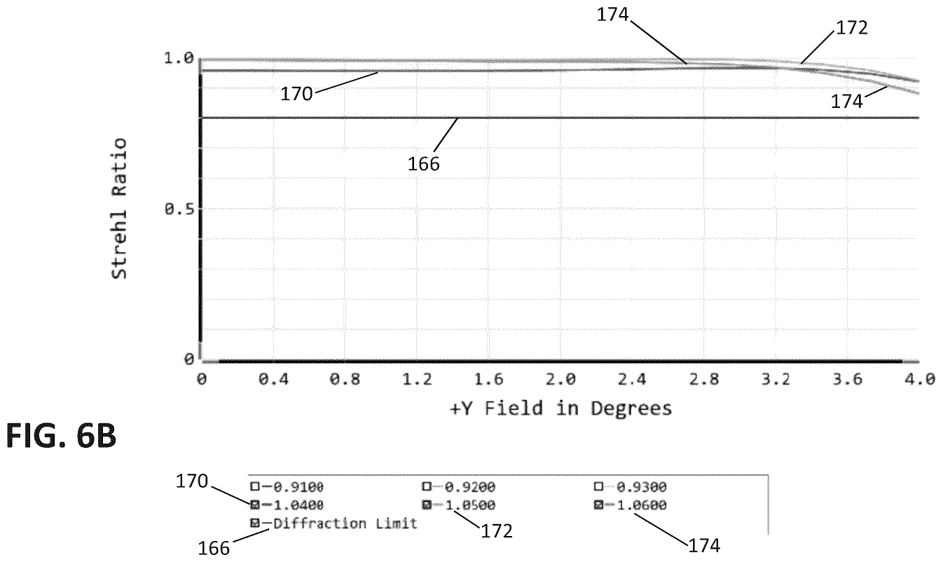

FIGS. 6A and 6B are plots of Strehl Ratio (unitless) versus lateral (field) position, Y, (in degrees) for the microscope objective design of FIGS. 2, 3A and 3B. These plots of Strehl Ratio again show diffraction limited performance at least across a 4° field. The Strehl Ratio for the microscope objective 12 having the aperture sizes indicated in the tables in FIGS. 3A and 3B is depicted by the horizontal line 166 in FIGS. 6A and 6B. The Strehl Ratio for wavelengths 910 nm (160), 920 nm (162), and 930 nm (164) out to a 4° field are shown in FIG. 6A above this diffraction limit 166, for example, generally more than about 0.95. Similarly, the Strehl Ratio for wavelengths 1040 nm (170), 1050 nm (172), and 1060 nm (174) out to a 4° field are shown in FIG. 6B above this diffraction limit 166, for example, generally more than about 0.88.

Sufficient aberration correction, including both wavefront aberration correction and chromatic aberration correction is demonstrated for a microscope objective 12 having a numerical aperture of 0.55 to 0.62, and more particularly, from 0.59 to 0.61 and a working distance of 5 mm to 13 mm and, more particularly, from 6 mm to 12 mm or 7 to 11 mm or 8 to 10 mm or any range formed by any of these values. More specially, various microscope objectives 12 described herein have (e.g., in air) less than 0.1, 0.095, 0.090, 0.085, 0.080, 0.075, 0.070, 0.065, 0.060, 0.055, 0.050, 0.045, 0.040, 0.035, 0.030, 0.025, 0.020, 0.015, 0.010, 0.005 wave of RMS wavefront error or any range formed by any of these values or possible larger or smaller for at least one wavelength (e.g., possibly a wavelength output by the laser light source 16) over a field of at least ±0.5°, ±1°, ±1.5°, ±2°, ±2.5°, ±3°, ±3.5°, ±4°, ±4.5°, ±5°, or any range formed by any of these values or possibly larger or smaller. Such wavelengths may include 910 nm, 920 nm, 930 nm, 1040 nm, 1050 nm, 1060 nm or any range formed by any of these values or possible larger or smaller or longer or shorter wavelengths. Accordingly, various microscope objectives 12 described herein have (e.g., in air) less than 0.1, 0.095, 0.090, 0.085, 0.080, 0.075, 0.070, 0.065, 0.060, 0.055, 0.050, 0.045, 0.040, 0.035, 0.030, 0.025, 0.020, 0.015, 0.010, 0.005 wave of RMS wavefront error or any range formed by any of these values or possible larger or smaller over a wavelength band of 5 nm, 10 nm, 15 nm, 20 nm, 25 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm or any range or ranges formed by any of these values over a field of at least ±0.5°, ±1°, ±1.5°, ±2°, ±2.5°, ±3°, ±3.5°, ±4°, ±4.5°, ±5°, or any range formed by any of these values or possibly larger or smaller. Such wavelength bands may include 910 nm, 920 nm, 930 nm, 1040 nm, 1050 nm, 1060 nm or any range formed by any of these values or possible larger or smaller or longer or shorter wavelengths.

Additionally, various microscope objectives 12 described herein have a Strehl ratio (e.g., in air) of at least 0.99, 0.98, 0.97, 0.96, 0.95, 0.94, 0.93, 0.92, 0.91, 0.90, 0.89, 0.88, 0.87, 0.86, 0.85, 0.84, 0.83, 0.82, 0.81, 0.80, or any range formed by any of these values or possible larger or smaller for at least one wavelength (e.g., possibly a wavelength output by the laser light source 16) over a field of at least ±0.5°, ±1°, ±1.5°, ±2°, ±2.5°, ±3°, ±3.5°, ±4°, ±4.5°, ±5°, or any range formed by any of these values or possibly larger or smaller. Such wavelengths may include 910 nm, 920 nm, 930 nm, 1040 nm, 1050 nm, 1060 nm or any range formed by any of these values or possible larger or smaller or longer or shorter wavelengths. Accordingly, various microscope objectives 12 described herein have a Strehl ratio (e.g., in air) of at least 0.99, 0.98, 0.97, 0.96, 0.95, 0.94, 0.93, 0.92, 0.91, 0.90, 0.89, 0.88, 0.87, 0.86, 0.85, 0.84, 0.83, 0.82, 0.81, 0.80, or any range formed by any of these values or possible larger or smaller over a wavelength band of 5 nm, 10 nm, 15 nm, 20 nm, 25 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm or any range or ranges formed by any of these values over a field of at least ±0.5°, ±1°, ±1.5°, ±2°, ±2.5°, ±3°, ±3.5°, ±4°, ±4.5°, ±5°, or any range formed by any of these values or possibly larger or smaller. Such wavelength bands may include 910 nm, 920 nm, 930 nm, 1040 nm, 1050 nm, 1060 nm or any range formed by any of these values or possible larger or smaller or longer or shorter wavelengths.

Accordingly, advantageously microscope objective designs are disclosed herein that provide features that can be useful for microscopy applications. The microscope objective 12 and/or the microscope 10 in which the microscope objective is incorporated may, for example, have a numerical aperture (e.g., in air) of 0.5, 0.51, 0.52, 0.53, 0.54, 0.55, 0.56, 0.57, 0.58, 0.59, 0.6, 0.61, 0.62, 0.63, 0.64, 0.65 or any range formed by any of these values or possibly larger or smaller. This NA may be for a design wavelength such as the wavelength of the laser light source 16. The NA may, for example, be for 920 nm but may also be for other wavelengths. As discussed above, such wavelengths include 910 nm, 920 nm, 930 nm, 1040 nm, 1050 nm, 1060 nm or any range formed by any of these values or possible larger or smaller or longer or shorter wavelengths. The microscope objective 12 and/or the microscope 10 in which the microscope objective is incorporated may, for example, have a working distance in air of 5 mm, 6 mm, 7 mm, 8 mm, 9 mm, 10 mm, 11 mm, 12 mm, 13 mm, 14 mm, 15 mm, 16 mm, or any range formed by any of these values or possibly longer or shorter. Such working distances may facilitate in vivo (physiological) imaging including non-immersion in vivo imaging. The microscope objective 12 and/or the microscope in which the microscope objective is incorporated may, for example, have a field of view of 2.0 mm×2.0 mm, 2.3 mm×2.3 mm, 2.5 mm×2.5 mm, 2.8 mm×2.8 mm, 3 mm×3 mm, 3.5 mm×3.5 mm, 4 mm×4 mm, 4.5 mm×4.5 mm or any range formed by any of these values or possibly longer or shorter. The field of view need not be symmetric. In various implementations, the microscope objective 12 is diffraction limited over the field-of-views recited herein. In some implementations, such diffraction limited performance is with Root-Mean-Squared (RMS) wavefront error less than 0.072λ and with a Strehl ratio>0.8, where λ is wavelength. The RMS wavefront error (e.g., in air) may, for example, be less than or equal to 0.1λ, 0.09λ, 0.08λ, 0.07λ, 0.06λ, 0.05λ, 0.04λ, 0.03λ, 0.02λ, 0.01λ, 0.005λ, 0.003λ, 0.002λ, 0.001λ, or any range formed by any of these values or possibly larger or smaller. The Strehl ratio (e.g., in air) may, for example, be at least 0.65, 0.7, 0.75, 0.8, 0.85, 0.9, 0.95, 0.98, 0.99 or any range formed by any of these values or possibly larger or smaller. Likewise, the microscope objective 12 and/or the microscope 10 in which the microscope is incorporated may, for example, accommodate a scan angle of ±2°, ±2.5°, ±3°, ±3.5°, ±4°, ±4.5°, ±5° or any range formed by any of these values or possibly larger or smaller angles. In various implementations, the microscope objective 12 is diffraction limited any one or more over these ranges. The microscope objective 12 in this example is diffraction limited over a wavelength range of 0.86-1.1 microns. In some implementations, the microscope objective is configured to equip the correction collar for compensating spherical aberrations caused by the air-to-tissue index mismatching, the 0-0.35 mm thick coverslip, and/or the various thickness of materials. The microscope objective shown in FIG. 2 and having the prescription shown in FIGS. 3A and 3B is an air microscope objective. Accordingly, the values and ranges cited herein can apply to an air microscope objective. Similarly, such parameters (values and ranges) can apply to the performance of the microscope objective in air.

The microscope objective 12 when incorporated in a microscope 10 may, for example, provide a magnification of 6×, 7×, 8×, 9×, 10×, 11×, 12×, 13×, 14×, 15×, or any range formed by any of these values or possibly larger or smaller. In various designs, the pupil diameter is 20 mm. However, the pupil diameter can be 10 mm, 12 mm, 15 mm, 16 mm, 18 mm, 20 mm, 22 mm, 25 mm, or any range formed by any of these values or possibly larger or smaller.

Variations in the design of the microscope objective 12, however, are possible. For example, the radii of curvature, thicknesses, separations, materials (index of refraction and/or Abbe number), the clear aperture, or any combination of these may be different. For example, each of the lenses or lens elements may have a clear aperture of at least or more than 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, or may be in any range formed by any of these values or possible larger or smaller. At least one of the lens elements may have a clear aperture of at least or more than 35 mm, 36 mm, 38 mm, 39 mm, 40 mm, 41 mm, 42 mm, 43 mm, 44 mm, 45 mm or in any range formed by any of these values or possibly larger or smaller. Similarly, two, three, four, five, six, or seven lenses may have a clear aperture of at least or more than 25 mm, 26 mm, 28 mm, 29 mm, 30 mm, 31 mm, 32 mm, 33 mm, 34 mm, 35 mm, 36 mm, 38 mm, 39 mm, 40 mm, 41 mm, 42 mm, 43 mm, 44 mm, 45 mm or in any range formed by any of these values or possibly larger or smaller, depending on the design. Similarly, two, three, four, or five lenses or lens elements between the lens or lens element closest to the proximal end and the lens or lens element closest to the distal end of the microscope objective may have a clear aperture of at least or more than 25 mm, 26 mm, 27 mm, 28 mm, 29 mm, 30 mm, 31 mm, 32 mm, 33 mm, 34 mm, 35 mm, 36 mm, 38 mm, 39 mm, 40 mm, 41 mm, 42 mm, 43 mm, 44 mm, 45 mm or in any range formed by any of these values or possibly larger or smaller, depending on the design. However, in some implementations, lenses or lens elements in the microscope objective 12 with smaller clear apertures and/or lens diameters and/or optical surface diameters are possible. The clear aperture may be reduced, for example, by adding a lens or lens element or multiple lens or lens elements, e.g., at the proximal end or closer to the proximal end than the distal end such as in the first stage.

The microscope 10 may comprise a laser scanning microscope, a fluorescence microscope, a two-photon laser scanning microscope, or a shortwave infrared (SWIR) microscope. Various objective designs described herein can also potentially work well for wide-field 1-photon fluorescence microscopy and non-fluorescence based microscopy, e.g., at the wavelength around 900 nm-1050 nm, since this objective is diffraction-limited in this range. The microscope objective 12 may, for example, be achromatic over the design excitation bandwidth. As illustrated in FIG. 4B, the microscope objective 12 may exhibit less than 5 microns of field curvature or variation in focus across the field (e.g., variation in focal plane or Z plane) over the design bandwidth, and provide diffraction limited focusing over that wavelength range. This field curvature or variation in focus across the field may be 0.5 microns, 1 micron, 2 micron, 3 microns, 4 microns, 5 microns or any range formed by any of these values or possibly larger or smaller. Additionally, this wavelength range may be 0.01 microns, 0.1 microns, 0.5 microns, 1 micron, 2 microns wide or any range formed by any of these values or possibly larger or smaller. The plot in FIG. 4A extends the field over ±4.0°. Accordingly, the field may be ±1°, ±2°, ±3°, ±4°, ±5°, ±6°, or any range formed by any of these values or possibly larger or smaller. The microscope objective 12 may be employed in a system that directs laser pulses onto the sample and such microscope objective advantageously introduces a limited the amount of pulse distortion or broadening as a result of propagating through the microscope objective. The microscope objective 12 may, for example, provide low pulse front distortion and/or pulse broadening as a result of chromatic dispersion, such as less than 200 femtoseconds (fs), 175 fs, 150 fs, 140 fs, 130 fs, 120 fs, 110 fs, 100 fs, 90 fs, 80 fs, 75 fs, 60 fs, 50 fs, 40 fs, 25 fs, 15 fs, 5 fs, or any range formed by any of these values or possible larger or smaller. This amount may correspond to the added temporal duration introduced by the chromatic dispersion.

The microscope objective 12 may have sufficiently high transmission in visible and/or near infrared. Reducing the number of lenses in the microscope objected assists in increasing transmission. Nevertheless, while the objective shown in FIG. 2 has seven lens elements, the objective may include more than 7 lens elements. Using more lens elements may be easier to achieve the same design performance.

As discussed above, in various implementations, the microscope objective 12 is an air objective, which can be beneficial for in vivo imaging and/or physiology imaging. The microscope objective may have a working distance of at least 5 or 6 mm or 7 or 8 mm in air. The microscope objective may, for example, have working distance in air of 5 mm, 5.5 mm, 6.0 mm, 6.5 mm, 7.0 mm, 7.5 mm, 8 mm, 8.5 mm, 9 mm, 9.5 mm, 10 mm, 11 mm, 12 mm, 13 mm, 14 mm, 15 mm, 16 mm, 18 mm, 20 mm, 22 mm, or any range formed by any of these values or possibly larger or smaller. In various implementations, the microscope objective has a NA of at least 0.55 mm in air. The microscope objective may for example have NA in air of 0.5, 0.51, 0.52, 0.53, 0.54, 0.55, 0.56, 0.57, 0.58, 0.59, 0.6, 0.61, 0.62, 0.63, 0.64, 0.65 or any range formed by any of these values or possibly larger or smaller. As discussed, these microscope objectives may be employed for multi-photon imaging. Such multiphoton imaging may have excitation wavelengths in the range of 900-1100 nm for two-photon imaging. Such multiphoton imaging may have excitation wavelengths over a broader band such as 800-1300 nm to include two-photon imaging and three photon imaging. Such multiphoton imaging may even have very extended excitation wavelengths across the NIR wavelengths of 750-1800 nm to enable two-photon, three-photon, and four-photon imaging. Accordingly, the microscope objective 12 may be diffraction limited over a wavelength range of 900-1100 nm or over a range of wavelength in the NIR or over a broad band. These microscope objectives 12 may be employed for physiology imaging.

A wide range of variations in design are possible. For example, the microscope objective shown in FIG. 2 has seven lens elements. In other designs, the number of lens element is more than seven and may for example be eight lens elements. In other designs, the number of lines elements is less than seven lens elements. Similarly, the microscope objective shown in FIG. 2 has four lenses or four stages (four and only four lenses or four and only four stages). In other designs, the number of lenses or stages is more than four and may for example be five. In other designs, the number of lenses or stages is less than four and may for example be three. Additionally, in some implementations, one or more optical surfaces in the microscope objective 12 may comprise an aspheric optical surface. Likewise, one more lenses or lens elements may comprise an aspheric lens or lens element. Alternatively, or additionally, one or more surface and/or lens or lens element may comprise a diffractive optical element. Use of such aspheric surfaces and/or lenses or lens elements may enable the number of lenses, lens elements and/or stages to be reduced. Likewise, use of such diffractive optical elements may enable the number of lenses, lens elements and/or stages to be reduced. Additionally, increasing the number of lens elements, lenses, and/or stages, may enable the clear aperture of the lens elements to be reduced.

In the design shown in FIG. 2, the first stage 44 has negative optical power, the second and third stages 62, 74 together provide positive power and the four stage 99 provides positive power. Also in the design shown in FIG. 2, the ratio of the height of the marginal ray at output of the first lens group, lens, and/or first lens element 44, 46, hₑₓᵢₜ, for an object at the center of the focal plane 14 (e.g., intersection of optical axis or central axis of objective through the focal plane) of the objective proximal the last lens element 100 versus the maximum height, hₘₐₓ, of the marginal ray through the objective (e.g., through the lens element 64 in the second group 62) is referred to herein as the retrofocus factor, r, (e.g., r=hₑₓᵢₜ/hₘₐₓ). See also “Systematic design of microscope objective. Part II: Lens module and design principles,” Yueqian Zhang and Herbert Gross, Advanced Optical Technologies, Volume 8, Issue 5, Jun. 7, 2019 (https://doi.org/10.1515/aot-2019-0013). The retrofocus factor may be, for example, about 0.5 (e.g., 0.495). Accordingly, the retrofocus factor may be 0.2, 0.25, 0.3, 0.35, 0.4, 0.45, 0.5, 0.55, 0.6, 0.65, 0.7, 0.75, 0.8, 0.85, 0.9, 0.95, 1.0 or in any range formed by any of these values or possibly larger or smaller. As discussed above, this microscope objective 12 may include, going from the focal plane 14 to the negative lens 46: a positive stage or lens 99, a positive group 74, 76, and a negative lens or stage 44. Other designs, however, are possible.

Although the microscope objective described herein may be employed for microscopy and other imaging applications, the objective may also be employed for non-imaging applications. Some such non-imaging applications include but are not limited to laser manufacturing, 3D printing, and polymerization such as two photon polymerization. Accordingly, the objective may be employed in non-imaging optical systems such as laser manufacturing systems, 3D printers, two photon polymerization systems or other polymerization systems. Even though such systems and/or applications do not necessarily comprises microscopes, the objective may be referred to as a microscope objective or possibly as an objective.

### EXAMPLES

This disclosure provides various examples of devices, systems, and methods of. Some such examples include but are not limited to the following examples.

### Examples—Part I

1. A microscope objective having a first proximal end and a second distal end, said distal end configured to be closer to a sample than said proximal end, said microscope objective comprising:
a first stage comprising a diverging lens element having negative optical power such that collimated light incident on said diverging lens element is caused by said diverging lens element to diverge as said light propagates away from said diverging lens element in the direction of said distal end of said microscope objective;
a second stage comprising a lens configured to receive said diverging beam and to cause the diverging beam to begin to converge from the widest lateral extent of the beam in the microscope objective or be collimated, said second stage more distal than said first stage;
a third stage comprising multiple lens elements, said third stage more distal than said second stage such that said lens in said second stage is located between said diverging lens element in said first stage and said multiple lens elements in said third stage; and
a fourth stage comprising a distal focusing lens having positive optical power to focus the beam down, said distal focusing lens being the lens that is closest to the focus of said microscope objective where said collimated light incident on the proximal end of said microscope objective will be focused, said fourth stage being more distal than said third stage such multiple lens elements in said third stage is between said lens in said second stage and said distal focusing lens in said fourth stage,
wherein said microscope objective has a numerical aperture in the range from 0.55 to 0.65.

2. The microscope objective of Example 1, wherein said diverging lens element in said first stage comprises a bi-concave lens element.

3. The microscope objective of Example 1 or 2, wherein said diverging lens element in said first stage comprises first and second surfaces, said first surface more proximal than said second surface, wherein said first surface has the highest curvature of any of the optical surfaces in said microscope objective.

4. The microscope objective of any of the examples above, wherein said diverging lens element in the first stage has first and second surfaces, said second surface more distal than said first surface, wherein said second surface comprises a concave surface.

5. The microscope objective of Example 4, wherein said second surface has a curvature greater than 1/200 mm⁻¹.

6. The microscope objective of Example 4, wherein said second surface has a curvature greater than 1/100 mm⁻¹.

7. The microscope objective of any of the examples above, wherein said diverging lens element has a clear aperture at least 36 mm.

8. The microscope objective of any of the examples above, wherein said diverging lens element has a clear aperture at least 38 mm.

9. The microscope objective of any of the examples above, wherein said first stage further comprises a positive lens element.

10. The microscope objective of Example 9, wherein said pair of said diverging lens element and said positive lens element in the first stage together having negative optical power.

11. The microscope objective of Example 9 or 10, wherein said first stage comprises a doublet comprising said diverging lens element having negative optical power and said positive lens element, the pair together having negative optical power.

12.The microscope objective of Example 11, wherein said doublet has a clear aperture greater than 36 mm.

13. The microscope objective of Example 11, wherein said doublet has a clear aperture at least 38 mm.

14. The microscope objective of any of Examples 9-13, wherein said diverging lens element is adhered to the positive lens element that forms part of said first stage.

15. The microscope objective of any of Examples 9-13, wherein said diverging lens element is spaced apart from to the positive lens element that forms part of said first stage by a gap.

16. The microscope objective of any of Examples 9-15, wherein said positive lens element in the first stage has first and second surfaces, said second surface more distal than said first surface, wherein said first surface comprises a convex surface.

17. The microscope objective of Example 16, wherein said first surface has a curvature greater than 1/200 mm⁻¹.

18. The microscope objective of Example 16, wherein said first surface has a curvature greater than 1/100 mm⁻¹.

19. The microscope objective of any of Examples 9-18, wherein said positive lens element in the first stage has first and second surfaces, said second surface more distal than said first surface, wherein said second surface comprises a convex surface.

20. The microscope objective of any of Examples 9-19, wherein said positive lens element in the first stage comprises a biconvex lens.

21. The microscope objective of any of Examples 9-20, wherein said lens in said second stage is separated from said positive lens element in the first stage by a gap of at least 4 mm.

22. The microscope objective of any of Examples 9-20, wherein said lens in said second stage is separated from said positive lens element in the first stage by a gap of at least 6 mm.

23. The microscope objective of any of the examples above, wherein said second stage is separated from said first stage by more than 8 mm.

24. The microscope objective of any of the examples above, wherein said lens element in said first stage and/or said lens in said second stage are configured to move with respect to said third stage.

25. The microscope objective of any of the examples above, wherein said first stage and said second stage are configured to move with respect to said third stage.

26. The microscope objective of any of the examples above, wherein said lens in said second stage is configured to move with respect to said multiple lens elements in said third stage by turning a collar on a housing of said microscope objective.

27. The microscope objective of any of the examples above, wherein said lens in said second stage is configured to move within said microscope objective.

28. The microscope objective of any of the examples above, wherein said lens in said second stage comprises by biconvex lens.

29. The microscope objective of any of the examples above, wherein said lens in said second stage has a proximal surface having a curvature of greater than 1/150 mm⁻¹.

30. The microscope objective of any of the examples above, wherein said lens in said second stage has a distal surface having a curvature of less than 1/100 mm⁻¹.

31. The microscope objective of any of the examples above, wherein said lens in said second stage has a thickness of at least 9 mm.

32. The microscope objective of any of the examples above, wherein said lens in said second stage has a clear aperture of at least 40 mm.

33. The microscope objective of any of the examples above, wherein said lens in said second stage has a clear aperture of at least 44 mm.

34. The microscope objective of any of the examples above, wherein said multiple lens elements comprises three lens elements: a first positive lens element, a second negative lens element, and a third positive lens element, with the second negative lens element between the first and third positive lens elements.

35. The microscope objective of any of the examples above, wherein said multiple lens elements comprises three lens elements: a first biconvex lens element, a second biconcave lens element, and a third biconvex lens element, with the second biconcave lens element is between the first and third positive lens elements.

36. The microscope objective of any of the examples above, wherein said lens comprising multiple lens elements comprises a triplet including said first positive power lens element, said second negative power lens element and said third positive lens element adhered together.

37. The microscope objective of any of Examples 34-35, wherein said first positive power lens element and said second negative power lens element in said multiple lens elements or said second negative lens element and said third positive lens element in said multiple lens elements are separated apart by a gap.

38. The microscope objective of any of Examples 34-35, wherein said first positive power lens element and said second negative power lens element in said multiple lens elements as well as said second positive lens element and said third positive lens element in multiple lens elements are separated apart by gaps.

39. The microscope objective of any of the examples above, wherein said multiple lens elements together has a clear aperture of at least 35 mm.

40. The microscope objective of any of the examples above, wherein multiple lens elements together has a clear aperture of at least 38 mm.

41. The microscope objective of any of the examples above, wherein said multiple lens elements together has a clear aperture of at least 40 mm.

42. The microscope objective of any of the examples above, wherein said multiple lens elements comprises a first positive lens and a second negative lens, wherein said second negative lens has a distal surface with a curvature of greater than 1/50 mm⁻¹.

43. The microscope objective of any of the examples above, wherein said multiple lens elements in said third stage is separated from said distal focusing lens in said fourth stage by a gap comprising at least 0.2 mm.

44. The microscope objective of any of the examples above, wherein said distal focusing lens in said fourth stage comprises a meniscus lens.

45. The microscope objective of any of the examples above, wherein said distal focusing lens in said fourth stage has a thickness of at least 12 mm.

46. The microscope objective of any of the examples above, wherein said microscope objective has a working distance of from 5 mm to 16 mm.

47. The microscope objective of any of the examples above, wherein said microscope objective has a working distance of from 6 mm to 15 mm.

48. The microscope objective of any of the examples above, wherein said microscope objective has a working distance of from 7 mm to 13 mm.

49. The microscope objective of any of the examples above, wherein said microscope objective is configured to accommodate a scan angle of ±4°.

50. The microscope objective of any of the examples above, wherein said microscope objective is configured to accommodate a field of view of 2.3 mm×2.3 mm.

51. The microscope objective of any of the examples above, further comprising a housing for said first through fourth stages with M32×0.75 threads at the proximal end.

52. The microscope objective of any of the examples above, further comprising a housing that has a lateral spatial extent of greater than 50 mm.

53. The microscope objective of any of the examples above, further comprising a housing that has a lateral spatial extent of greater than 60 mm.

54. The microscope objective of any of the examples above, further comprising a housing that has a lateral spatial extent of at least 65 mm.

55. The microscope objective of any of the examples above, wherein said microscope objective is diffraction limited for at least one wavelength.

56. The microscope objective of any of the examples above, wherein said microscope objective provides for non-immersion in vivo imaging.

57. The microscope objective of any of the examples above, included in a fluorescent microscope having a light source outputting light having a wavelength, said microscope being diffraction limited for said wavelength.

58. The microscope objective of any of the examples above, included in a microscope so as to provide a magnification of from 8× to 15×.

59. A microscope including said microscope objective of any of the examples above, said microscope including a light source configured to direct light through the microscope objective to the sample.

60. The microscope of Example 59, wherein said microscope comprises a laser scanning microscope, a fluorescence microscope, a two-photon laser scanning microscope, three-photon microscopy, harmonics-generation microscopy, Raman scattering (SRS) microscopy, coherent anti-stoke Raman scattering (CARS) microscopy, or nonlinear microscopy or a short wave infrared (SWIR) microscope.

61. The microscope objective of any of the examples above, wherein said microscope objective comprises an air objective.

62. The microscope objective of any of the examples above, wherein said microscope objective has a NA in air of from 0.55 to 0.65,

63. The microscope objective of any of the examples above, wherein said microscope objective has a working distance in air of from 8 mm to 12 mm.

64. The microscope objective of any of the examples above, wherein the most proximal two lens elements in said multiple lens elements in said third stage have clear apertures of at least 40 mm.

65. The microscope objective of any of the examples above, wherein the most proximal two lens elements in said multiple lens elements in said third stage have clear apertures of at least 44 mm.

66. The microscope objective of any of the examples above, wherein said multiple lens elements in said third stage has chromatic aberration to compensate for chromatic aberration contributed by refractive optics in the microscope objective.

67. The microscope objective of any of the examples above, wherein said multiple lens elements in said third stage has chromatic aberration to compensate for chromatic aberration in all said other refractive optics in the microscope objective.

68. The microscope objective of any of the examples above, wherein one or more surfaces on one or more lenses or lens elements comprise an aspheric surface.

69. The microscope objective of any of the examples above, wherein one or more lenses or lens elements comprise an aspheric lens or aspheric lens element.

70. The microscope objective of any of the examples above, wherein one or more surfaces on one or more lenses or lens elements comprise a diffractive optical element.

71. The microscope objective of any of the examples above, wherein one or more lens or lens elements comprise a diffractive optical element.

72. The microscope objective of any of the examples above, further comprising an additional lens element.

73. The microscope objective of any of the examples above, having a retrofocus factor of from 0.25 to 1.0.

74. The microscope objective of any of the examples above, wherein the number of lens elements is in the microscope objective is seven and only seven.

75. The microscope objective of any of the examples above, wherein the number of lens elements is more than seven.

76. The microscope objective of any of the examples above, wherein the number of lens elements is in the microscope objective is eight and only eight.

77. The microscope objective of any of the examples above, wherein the number of lens elements is in the microscope objective is six and only six.

78. The microscope objective of any of the examples above, wherein said microscope objective comprises no more than four lenses.

79. The microscope objective of any of the examples above, wherein said microscope objective comprises four lenses and only four lenses.

80. A laser manufacturing system comprising the microscope objective of any of the examples above.

81. A 3D printer comprising the microscope objective of any of the examples above.

82. A two photon polymerization system comprising the microscope objective of any of the examples above.

83. The microscope objective of any of the examples above, wherein said working distance is from 8 mm to 11 mm.

84. The microscope objective of any of the examples above, wherein said working distance is from 8 mm to 10 mm.

### Examples—Part II

1. A microscope objective having a first proximal end and a second distal end, said distal end configured to be closer to a sample than said proximal end, said microscope objective comprising:
seven lens elements having optical power within a housing arranged along a longitudinal optical path, said seven lens elements comprising:
   a first lens element having negative optical power,
   a second lens element having positive optical power,
   a third lens element having positive optical power, said second lens element between said first lens element and said third lens element;
   a lens triplet comprising a fourth lens element, a fifth lens element, and a sixth lens, with said fifth lens element between said fourth lens element and said sixth lens element, said fourth and sixth lens elements having positive optical power and the fifth lens element having negative optical power; and
   a seventh lens element positioned to be closest said sample, said seventh lens element having positive optical power, said triplet between said seventh lens element and said third lens element,
wherein said microscope objective has a working distance in a range from 5 mm to 16 mm and a numerical aperture of in a range from 0.50 to 0.65 in air.

2. The microscope objective of Example 1, wherein said working distance is from 6 to mm.

3. The microscope objective of Example 1, wherein said working distance is from 6 to mm.

4. The microscope objective of Example 1, wherein said working distance is from 7 to mm.

5. The microscope objective of any of the examples above, wherein said numerical aperture is in a range from 0.55 to 0.65.

6. The microscope objective of any of the examples above, wherein said numerical aperture is in a range from 0.57 to 0.63.

7. The microscope objective of any of the examples above, wherein said numerical aperture is in a range from 0.59 to 0.61.

8. The microscope objective of any of the examples above, wherein the first lens element comprises first and second surfaces, said first surface more proximal than said second surface, wherein said first surface has the highest curvature of any of the optical surfaces in said microscope objective.

9. The microscope objective of any of the examples above, wherein said first lens element has first and second surfaces, said second surface more distal than said first surface, wherein said second surface comprises a concave surface.

10. The microscope objective of Example 9, wherein said second surface has a curvature greater than 1/300 mm⁻¹.

11. The microscope objective of Example 9, wherein said second surface has a curvature greater than 1/100 mm⁻¹.

12. The microscope objective of any of the examples above, wherein said first lens element has a lateral extent larger than 20 millimeters.

13. The microscope objective of any of the examples above, wherein said first lens element has a lateral extent at least 40 millimeters.

14. The microscope objective of any of the examples above, wherein said first lens element is a biconcave lens.

15. The microscope objective of any of the examples above, wherein said second lens element has first and second surfaces, said second surface more distal than said first surface, wherein said first surface comprises a convex surface.

16. The microscope objective of Example 15, wherein said first surface has a curvature greater than 1/300 mm⁻¹.

17. The microscope objective of Example 15, wherein said first surface has a curvature greater than 1/100 mm⁻¹.

18. The microscope objective of any of the examples above, wherein said second lens element is a biconvex lens element.

19. The microscope objective of any of the examples above, wherein said first and second lens elements are combined together to form a lens doublet.

20. The microscope objective of Example 19, wherein said doublet has a clear aperture larger than 36 mm.

21. The microscope objective of Example 19, wherein said doublet has a clear aperture larger than 38 mm.

22. The microscope objective of any of the examples above, wherein said third lens element is separated from said second lens by a gap of at least 6 mm.

23. The microscope objective of any of the examples above, wherein the third lens element is configured to move with respect to said fourth lens.

24. The microscope objective of any of the examples above, wherein said third lens element is a biconvex lens.

25. The microscope objective of any of the examples above, wherein said third lens element has a proximal surface having a curvature of greater than 1/150 mm⁻¹.

26. The microscope objective of any of the examples above, wherein said third lens element has a distal surface having a curvature of less than 1/100 mm⁻¹.

27. The microscope objective of any of the examples above, wherein said third lens element has a thickness of at least 9 mm.

28. The microscope objective of any of the examples above, wherein said third lens element has a clear aperture of at least 40 mm.

29. The microscope objective of any of the examples above, wherein said third lens element has a clear aperture of at least 43 mm.

30. The microscope objective of any of the examples above, wherein said fourth and sixth lens elements are biconvex and said fifth lens element is biconcave.

31. The microscope objective of any of the examples above, wherein said triplet has a clear aperture of at least 35 mm.

32. The microscope objective of any of the examples above, wherein said triplet has a clear aperture of at least 38 mm.

33. The microscope objective of any of the examples above, wherein said fifth lens element has a distal surface with a curvature of greater than 1/50 mm⁻¹.

34. The microscope objective of any of the examples above, wherein said seventh lens element is a meniscus lens.

35. The microscope objective of any of the examples above, wherein one of said fourth and sixth lens elements have Abbe number that are at least twice as large as the Abbe number of the fifth lens element.

36. The microscope objective of any of the examples above, wherein said seventh lens element has a thickness of at least 12 mm.

37. The microscope objective of any of the examples above, wherein said seventh lens element has the smallest clear aperture of said seven lens elements.

38. The microscope objective of any of the examples above, wherein said seventh lens element has the most positive optical power of said seven lens elements.

39. The microscope objective of any of the examples above, wherein said seventh lens element has the most optical power of said seven lens elements.

40. The microscope objective of any of the examples above, wherein said third lens element has a clear aperture at least as large or larger than the clear aperture of seven lens elements.

41. The microscope objective of any of the examples above, wherein said microscope objective is configured to accommodate a scan angle of ±4°.

42. The microscope objective of any of the examples above, wherein said microscope objective is configured to have a field of view of 2.3 mm×2.3 mm.

43. The microscope objective of any of the examples above, wherein said microscope objective has a focal length of from 14 mm to 25 mm.

44. The microscope objective of any of the examples above, further comprising a housing for said first through seventh lens elements with M32×0.75 threads at the proximal end.

45. The microscope objective of any of the examples above, further comprising a housing that has a lateral spatial extent of greater than 50 mm.

46. The microscope objective of any of the examples above, further comprising a housing that has a lateral spatial extent of at least 60 mm.

47. The microscope objective of any of the examples above, wherein said microscope objective has an entrance pupil that is in the range from 18 mm to 22 mm in lateral extent.

48. The microscope objective of any of the examples above, wherein said first and second lens elements together have a thickness of at least 20 mm.

49. The microscope objective of any of the examples above, wherein said first and second lens elements together have a thickness of at least 25 mm.

50. The microscope objective of any of the examples above, wherein said seventh lens element has a thickness of at least 12 mm.

51. The microscope objective of any of the examples above, wherein said microscope objective is diffraction limited for at least one wavelength.

52. The microscope objective of any of the examples above, wherein said microscope objective provides for non-immersion in vivo imaging.

53. The microscope objective of any of the examples above, included in a microscope so as to provide a magnification of from 8× to 15×.

54. The microscope objective of any of the examples above, included in a fluorescent microscope having a light source outputting light having a wavelength, said microscope being diffraction limited for said wavelength.

55. The microscope objective of any of the examples above, wherein said microscope objective comprises no more than seven lens elements having optical power.

56. A microscope including said microscope objective of any of the examples above, said microscope including a light source configured to direct light through the microscope objective to the sample.

57. The microscope of Example 56, wherein said microscope comprises a laser scanning microscope, a fluorescence microscope, a two-photon laser scanning microscope, three-photon microscopy, harmonics-generation microscopy, Raman scattering (SRS) microscopy, coherent anti-stoke Raman scattering (CARS) microscopy, or nonlinear microscopy or a short wave infrared (SWIR) microscope.

58. The microscope objective of any of the examples above, wherein said microscope objective comprises an air objective.

59. The microscope objective of any of the examples above, wherein said microscope objective has a NA in air at from 0.55 to 0.65.

60. The microscope objective of any of the examples above, wherein said microscope objective has a working distance in air of from 7 to 12 mm.

61. The microscope objective of any of the examples above, wherein said fourth, fifth and sixth lens elements in said third stage have chromatic aberration to compensate for chromatic aberration in other lens elements in the microscope objective.

62. The microscope objective of any of the examples above, wherein said fourth, fifth and sixth lens elements in said third stage have chromatic aberration to compensate for chromatic aberration in all said other lens elements in the microscope objective.

63. The microscope objective of any of the examples above, wherein one or more surfaces on one or more lens elements comprise an aspheric surface.

64. The microscope objective of any of the examples above, wherein one or more lens elements comprise an aspheric lens or aspheric lens element.

65. The microscope objective of any of the examples above, wherein one or more surfaces on one or more lens elements comprise a diffractive optical element.

66. The microscope objective of any of the examples above, wherein one or more lens elements comprise a diffractive optical element.

67. The microscope objective of any of the examples above, having a retrofocus factor of from 0.25 to 1.0.

68. The microscope objective of any of the examples above, wherein the number of lens elements is in the microscope objective is seven and only seven.

69. The microscope objective of any of the examples above, wherein the number of lens elements is more than seven.

70. The microscope objective of any of the examples above, wherein the number of lens elements is in the microscope objective is eight and only eight.

71. The microscope objective of any of the examples above, wherein said microscope objective comprises no more than four lenses.

72. The microscope objective of any of the examples above, wherein said microscope objective comprises four lenses and only four lenses.

73. A laser manufacturing system comprising the microscope objective of any of the examples above.

74. A 3D printer comprising the microscope objective of any of the examples above.

75. A two photon polymerization system comprising the microscope objective of any of the examples above.

76. The microscope objective of any of the examples above, wherein said working distance is from 8 mm to 11 mm.

77. The microscope objective of any of the examples above, wherein said working distance is from 8 mm to 10 mm.

### Examples—Part III

1. A microscope objective having a first proximal end and a second distal end, said distal end configured to be closer to a sample than said proximal end, said microscope objective comprising:
a housing; and
a plurality of lens elements having optical power within said housing arranged along a longitudinal optical path within said housing, said plurality of lens elements including a lens element closest to the proximal end, a lens element closest to said distal end and a plurality of lens elements therebetween,
wherein said microscope objective has a working distance in the range from 5 mm to 16 mm and a numerical aperture in the range from 0.55 to 0.65 in air.

2. The microscope objective of Example 1, wherein said lens elements have clear apertures of greater than 18 mm.

3. The microscope objective of any of the examples above, wherein each of said lens elements has a clear aperture of at least 24 mm.

4. The microscope objective of any of the examples above, wherein each of said lenses has a clear aperture of at least 28 mm.

5. The microscope objective of any of the examples above, wherein each of said lenses has a clear aperture of at least 32 mm.

6. The microscope objective of any of the examples above, wherein at least one of said lens elements has a clear aperture of larger than 35 mm.

7. The microscope objective of any of the examples above, wherein at least one of said lens elements has a clear aperture of larger than 43 mm.

8. The microscope objective of any of the examples above, wherein at least some of the lens elements between the lens element closest to the proximal and the lens element closest to the distal ends have clear apertures of at least 30 mm.

9. The microscope objective of any of the examples above, wherein said plurality of lens elements comprise at least six of said lens elements having a clear aperture of greater than 30 mm.

10. The microscope objective of any of the examples above, wherein plurality of lens elements comprise at least seven of said lens elements having a clear aperture of greater than 30 mm.

11. The microscope objective of any of the examples above, wherein each of the lens elements between the lens elements closest to the proximal and distal ends have clear apertures of larger than 33 mm.

12. The microscope objective of any of the examples above, wherein each of the lens elements between the lens elements closest to the proximal and distal ends have clear apertures of larger than 35 mm.

13. The microscope objective of any of the examples above, wherein at least three lens elements have clear apertures of at least 40 mm.

14. The microscope objective of any of the examples above, wherein at least one of said lens elements has a clear aperture of larger than 42 mm.

15. The microscope objective of any of the examples above, wherein at least one of said lens elements has a clear aperture of at least 44 mm.

16. The microscope objective of any of the examples above, wherein said plurality of lens elements comprise 7 lens elements and said microscope objective includes no more than 7 lens elements.

17. The microscope objective of any of the examples above, wherein at least three of said lens elements are included in a triplet.

18. The microscope objective of Example 17, wherein said triplet has chromatic aberration to compensate for chromatic aberration in other lens elements in the microscope objective.

19. The microscope objective of Example 17, wherein said triplet has chromatic aberration to compensate for chromatic aberration in other all other lens elements in the microscope objective.

20. The microscope objective of any of the examples above, wherein at least two of said lens elements are included in a doublet.

21. The microscope objective of any of the examples above, wherein said plurality of lens elements comprise 6 lens elements and said microscope objective includes no more than 6 lens elements.

22. The microscope objective of Example 21, wherein at least one of said lens elements has an aspheric optical surface.

23. The microscope objective of any of the examples above, wherein said microscope objective has a working distance of between 6 mm and 15 mm.

24. The microscope objective of any of the examples above, wherein said microscope objective has a numerical aperture of between 0.58 to 0.61.

25. The microscope objective of any of the examples above, wherein said microscope objective is diffraction limited for at least one wavelength.

26. The microscope objective of any of the examples above, wherein said microscope objective has less than 0.1 wave of RMS wavefront error for at least one wavelength over a field of ±2°.

27. The microscope objective of any of the examples above, wherein said microscope objective has less than 0.1 wave of RMS wavefront error for at least one wavelength over a field of ±4°.

28. The microscope objective of any of the examples above, wherein said microscope objective has less than 0.1 wave of RMS wavefront error over a range of wavelength of at least 20 nm over a field of ±2°.

29. The microscope objective of any of the examples above, wherein said microscope objective has less than 0.1 wave of RMS wavefront error over a range of wavelength of at least 20 nm over a field of ±4°.

30. The microscope objective of any of the examples above, wherein said microscope objective has less than 0.06 wave of RMS wavefront error for at least one wavelength over a field of ±2°.

31. The microscope objective of any of the examples above, wherein said microscope objective has less than 0.06 wave of RMS wavefront error for at least one wavelength over a field of ±4°.

32. The microscope objective of any of the examples above, wherein said microscope objective has less than 0.06 wave of RMS wavefront error over a range of wavelength of at least 20 nm over a field of ±2°.

33. The microscope objective of any of the examples above, wherein said microscope objective has less than 0.06 wave of RMS wavefront error over a range of wavelength of at least 20 nm over a field of ±4°.

34. The microscope objective of any of the examples above, wherein said microscope objective has a Strehl ratio of at least 0.8 for at least one wavelength at over field of ±2°.

35. The microscope objective of any of the examples above, wherein said microscope objective has a Strehl ratio of at least 0.8 for at least one wavelength over a field of ±4°.

36. The microscope objective of any of the examples above, wherein said microscope objective has a Strehl ratio of at least 0.93 for at least one wavelength at a field of ±2°.

37. The microscope objective of any of the examples above, wherein said microscope objective has a Strehl ratio of at least 0.93 for at least one wavelength at a field of ±4°.

38. The microscope objective of any of the examples above, wherein said microscope objective has a Strehl ratio of at least 0.8 for over a wavelength range of at least 20 nm over field of ±2°.

39. The microscope objective of any of the examples above, wherein said microscope objective has a Strehl ratio of at least 0.8 over a wavelength range of at least 20 nm over a field of ±4°.

40. The microscope objective of any of the examples above, wherein said microscope objective has a Strehl ratio of at least 0.93 over a wavelength range of at least 20 nm over a field of ±2°.

41. The microscope objective of any of the examples above, wherein said microscope objective has a Strehl ratio of at least 0.93 over a wavelength range of at least 20 nm over a field of ±4°.

42. The microscope objective of any of the examples above, included in a microscope so as to provide a magnification of from 8× to 16×.

43. The microscope objective of any of the examples above, included in a microscope so as to provide a magnification of from 9× to 15×.

44. The microscope objective of any of the examples above, further comprising a housing for said first through fourth stages with M32×0.75 threads at the proximal end.

45. The microscope objective of any of the examples above, included in a fluorescent microscope having a light source outputting light having a wavelength, said microscope being diffraction limited for said wavelength.

46. A microscope including said microscope objective of any of the examples above, said microscope including a light source configured to direct light through the microscope objective to the sample.

47. The microscope of Example 46, wherein said microscope comprises a laser scanning microscope, a fluorescence microscope, a two-photon laser scanning microscope, three-photon microscopy, harmonics-generation microscopy, Raman scattering (SRS) microscopy, coherent anti-stoke Raman scattering (CARS) microscopy, or nonlinear microscopy or a short wave infrared (SWIR) microscope.

48. The microscope objective of any of the examples above, wherein the lens element closest to said proximal end or the lens element closest to the distal end is the smallest.

49. The microscope objective of any of the examples above, wherein the lens element closest to said proximal end has negative optical power.

50. The microscope objective of any of the examples above, wherein the lens element closest to the distal end has positive optical power.

51. The microscope objective of any of the examples above, wherein at least some of the lens elements have clear apertures of at least 30 mm.

52. The microscope objective of any of the examples above, wherein at least some of the lens elements between the lens element closest to the proximal and the lens element closest to the distal ends have clear apertures of at least 30 mm.

53. The microscope objective of any of the examples above, wherein each of the lens elements between the lens element closest to the proximal and the lens element closest to the distal ends have clear apertures of larger than 30 mm.

54. The microscope objective of any of the examples above, wherein said microscope objective comprises no more than four lenses.

55. The microscope objective of Example 54, wherein one of said lens comprises a doublet comprising two lens elements and one of said lenses comprises a triplet comprising three lens elements.

56. The microscope objective of any of the examples above, wherein said microscope objective comprises no more than three lenses.

57. The microscope objective of any of the examples above, wherein said microscope objective comprises an air objective.

58. The microscope objective of any of the examples above, wherein said microscope objective has a working distance in air of from 6 to 14 mm.

59. The microscope objective of any of the examples above, wherein said microscope objective has a NA in air of from 0.55 to 0.65.

60. The microscope objective of any of the examples above, wherein said microscope objective diffraction limited in air between 910 nm and 1060 nm.

61. The microscope objective of any of the examples above, wherein said microscope objective diffraction limited in air between 910 nm and 1100 nm.

62. A microscope comprising the microscope objective of any of the examples above wherein said microscope comprises a multiphoton laser scanning microscope configured for in vivo imaging.

63. A microscope comprising the microscope objective of any of the examples above wherein said microscope comprises a multiphoton laser scanning microscope configured for in physiology imaging.

64. A microscope comprising the microscope objective of any of the examples above wherein said microscope comprises a multiphoton laser scanning microscope configured to operate at a wavelength in the wavelength range of 900-1100 nm.

65. A microscope comprising the microscope objective of any of the examples above wherein said microscope comprises a multiphoton laser scanning microscope configured to operate at a Near Infrared (NIR) wavelength.

66. The microscope objective of any of the examples above, wherein one or more surfaces on one or more lens elements comprise an aspheric surface.

67. The microscope objective of any of the examples above, wherein one or more lens elements comprise an aspheric lens or aspheric lens element.

68. The microscope objective of any of the examples above, wherein one or more surfaces on one or more lens elements comprise a diffractive optical element.

69. The microscope objective of any of the examples above, wherein one or more lens elements comprise a diffractive optical element.

70. The microscope objective of any of the examples above, wherein the number of lens elements is in the microscope objective is seven and only seven.

71. The microscope objective of any of the examples above, wherein the number of lens elements is more than seven.

72. The microscope objective of any of the examples above, wherein the number of lens elements is in the microscope objective is eight and only eight.

73. The microscope objective of any of the examples above, wherein the number of lens elements is less than seven.

74. The microscope objective of any of the examples above, wherein said microscope objective comprises four lenses and only four lenses.

75. The microscope objective of any of the examples above, wherein said microscope objective comprises three lenses and only three lenses.

76. The microscope objective of any of the examples above, having a retrofocus factor of from 0.25 to 1.0.

77. A laser manufacturing system comprising the microscope objective of any of the examples above.

78. A 3D printer comprising the microscope objective of any of the examples above.

79. A two photon polymerization system comprising the microscope objective of any of the examples above.

80. The microscope objective of any of the examples above, wherein said working distance is from 7 mm to 13 mm.

81. The microscope objective of any of the examples above, wherein said working distance is from 7 mm to 12 mm.

82. The microscope objective of any of the examples above, wherein said working distance is from 8 mm to 11 mm.

83. The microscope objective of any of the examples above, wherein said working distance is from 8 mm to 10 mm.

### Part I-B

1. A microscope objective having a first proximal end and a second distal end, said distal end configured to be closer to a sample than said proximal end, said microscope objective comprising:
a first stage comprising a diverging lens element having negative optical power such that collimated light incident on said diverging lens element is caused by said diverging lens element to diverge as said light propagates away from said diverging lens element in the direction of said distal end of said microscope objective;
a second stage comprising a lens configured to receive said diverging beam and to cause the diverging beam to begin to converge from the widest lateral extent of the beam in the microscope objective or be collimated, said second stage more distal than said first stage;
a third stage comprising multiple lens elements, said third stage more distal than said second stage such that said lens in said second stage is located between said diverging lens element in said first stage and said multiple lens elements in said third stage; and
a fourth stage comprising a distal focusing lens having positive optical power to focus the beam down, said distal focusing lens being the lens that is closest to the focus of said microscope objective where said collimated light incident on the proximal end of said microscope objective will be focused, said fourth stage being more distal than said third stage such multiple lens elements in said third stage is between said lens in said second stage and said distal focusing lens in said fourth stage,
wherein said microscope objective has a numerical aperture in the range from 0.55 to 0.65.

2. The microscope objective of Example 1, wherein said diverging lens element in said first stage comprises a bi-concave lens element.

3. The microscope objective of Example 1, wherein said diverging lens element in said first stage comprises first and second surfaces, said first surface more proximal than said second surface, wherein said first surface has the highest curvature of any of the optical surfaces in said microscope objective.

4. The microscope objective of Example 1, wherein said diverging lens element in the first stage has first and second surfaces, said second surface more distal than said first surface, wherein said second surface comprises a concave surface.

5. The microscope objective of Example 4, wherein said second surface has a curvature greater than 1/200 mm⁻¹.

6. The microscope objective of Example 4, wherein said second surface has a curvature greater than 1/100 mm⁻¹.

7. The microscope objective of Example 1, wherein said diverging lens element has a clear aperture at least 36 mm.

8. The microscope objective of Example 1, wherein said diverging lens element has a clear aperture at least 38 mm.

9. The microscope objective of Example 1, wherein said first stage further comprises a positive lens element.

10. The microscope objective of Example 9, wherein said pair of said diverging lens element and said positive lens element in the first stage together having negative optical power.

11. The microscope objective of Example 9, wherein said first stage comprises a doublet comprising said diverging lens element having negative optical power and said positive lens element, the pair together having negative optical power.

12. The microscope objective of Example 11, wherein said doublet has a clear aperture greater than 36 mm.

13. The microscope objective of Example 11, wherein said doublet has a clear aperture at least 38 mm.

14. The microscope objective of Example 9, wherein said diverging lens element is adhered to the positive lens element that forms part of said first stage.

15. The microscope objective of Example 9, wherein said diverging lens element is spaced apart from to the positive lens element that forms part of said first stage by a gap.

16. The microscope objective of any of Example 9, wherein said positive lens element in the first stage has first and second surfaces, said second surface more distal than said first surface, wherein said first surface comprises a convex surface.

17. The microscope objective of Example 16, wherein said first surface has a curvature greater than 1/200 mm⁻¹.

18. The microscope objective of Example 16, wherein said first surface has a curvature greater than 1/100 mm⁻¹.

19. The microscope objective of Example 9, wherein said positive lens element in the first stage has first and second surfaces, said second surface more distal than said first surface, wherein said second surface comprises a convex surface.

20. The microscope objective of Example 9, wherein said positive lens element in the first stage comprises a biconvex lens.

21. The microscope objective of Example 9, wherein said lens in said second stage is separated from said positive lens element in the first stage by a gap of at least 4 mm.

22. The microscope objective of Example 9, wherein said lens in said second stage is separated from said positive lens element in the first stage by a gap of at least 6 mm.

23. The microscope objective of Example 1, wherein said second stage is separated from said first stage by more than 8 mm.

24. The microscope objective of Example 1, wherein said lens element in said first stage and/or said lens in said second stage are configured to move with respect to said third stage.

25. The microscope objective of Example 1, wherein said first stage and said second stage are configured to move with respect to said third stage.

26. The microscope objective of Example 1, wherein said lens in said second stage is configured to move with respect to said multiple lens elements in said third stage by turning a collar on a housing of said microscope objective.

27. The microscope objective of Example 1, wherein said lens in said second stage is configured to move within said microscope objective.

28. The microscope objective of Example 1, wherein said lens in said second stage comprises by biconvex lens.

29. The microscope objective of Example 1, wherein said lens in said second stage has a proximal surface having a curvature of greater than 1/150 mm⁻¹.

30. The microscope objective of Example 1, wherein said lens in said second stage has a distal surface having a curvature of less than 1/100 mm⁻¹.

31. The microscope objective of Example 1, wherein said lens in said second stage has a thickness of at least 9 mm.

32. The microscope objective of Example 1, wherein said lens in said second stage has a clear aperture of at least 40 mm.

33. The microscope objective of Example 1, wherein said lens in said second stage has a clear aperture of at least 44 mm.

34. The microscope objective of Example 1, wherein said multiple lens elements comprises three lens elements: a first positive lens element, a second negative lens element, and a third positive lens element, with the second negative lens element between the first and third positive lens elements.

35. The microscope objective of Example 1, wherein said multiple lens elements comprises three lens elements: a first biconvex lens element, a second biconcave lens element, and a third biconvex lens element, with the second biconcave lens element is between the first and third positive lens elements.

36. The microscope objective of Example 1, wherein said lens comprising multiple lens elements comprises a triplet including said first positive power lens element, said second negative power lens element and said third positive lens element adhered together.

37. The microscope objective of Example 34, wherein said first positive power lens element and said second negative power lens element in said multiple lens elements or said second positive lens element and said third positive lens element in said multiple lens elements are separated apart by a gap.

38. The microscope objective of Example 34, wherein said first positive power lens element and said second negative power lens element in said multiple lens elements as well as said second negative lens element and said third positive lens element in multiple lens elements are separated apart by gaps.

39. The microscope objective of Example 1, wherein said multiple lens elements together has a clear aperture of at least 35 mm.

40. The microscope objective of Example 1, wherein multiple lens elements together has a clear aperture of at least 38 mm.

41. The microscope objective of Example 1, wherein said multiple lens elements together has a clear aperture of at least 40 mm.

42. The microscope objective of Example 1, wherein said multiple lens elements comprises a first positive lens and a second negative lens, wherein said second negative lens has a distal surface with a curvature of greater than 1/50 mm⁻¹.

43. The microscope objective of Example 1, wherein said multiple lens elements in said third stage is separated from said distal focusing lens in said fourth stage by a gap comprising at least 0.2 mm.

44. The microscope objective of Example 1, wherein said distal focusing lens in said fourth stage comprises a meniscus lens.

45. The microscope objective of Example 1, wherein said distal focusing lens in said fourth stage has a thickness of at least 12 mm.

46. The microscope objective of Example 1, wherein said microscope objective has a working distance of from 5 mm to 15 mm.

47. The microscope objective of Example 1, wherein said microscope objective has a working distance of from 6 mm to 14 mm.

48. The microscope objective of Example 1, wherein said microscope objective has a working distance of from 7 mm to 13 mm.

49. The microscope objective of Example 1, wherein said microscope objective is configured to accommodate a scan angle of ±4°.

50. The microscope objective of Example 1, wherein said microscope objective is configured to accommodate a field of view of 2.3 mm×2.3 mm.

51. The microscope objective of Example 1, further comprising a housing for said first through fourth stages with M32×0.75 threads at the proximal end.

52. The microscope objective of Example 1, further comprising a housing that has a lateral spatial extent of greater than 50 mm.

53. The microscope objective of Example 1, further comprising a housing that has a lateral spatial extent of greater than 60 mm.

54. The microscope objective of Example 1, further comprising a housing that has a lateral spatial extent of at least 65 mm.

55. The microscope objective of Example 1, wherein said microscope objective is diffraction limited for at least one wavelength.

56. The microscope objective of Example 1, wherein said microscope objective provides for non-immersion in vivo imaging.

57. The microscope objective of Example 1, included in a fluorescent microscope having a light source outputting light having a wavelength, said microscope being diffraction limited for said wavelength.

58. The microscope objective of Example 1, included in a microscope so as to provide a magnification of from 8× to 15×.

59. A microscope including said microscope objective of Example 1, said microscope including a light source configured to direct light through the microscope objective to the sample.

60. The microscope of Example 59, wherein said microscope comprises a laser scanning microscope, a fluorescence microscope, a two-photon laser scanning microscope, three-photon microscopy, harmonics-generation microscopy, Raman scattering (SRS) microscopy, coherent anti-stoke Raman scattering (CARS) microscopy, or nonlinear microscopy or a short wave infrared (SWIR) microscope.

61. The microscope objective of Example 1, wherein said microscope objective comprises an air objective.

62. The microscope objective of Example 1, wherein said microscope objective has a NA in air of from 0.55 to 0.65,

63. The microscope objective of Example 1, wherein said microscope objective has a working distance in air of from 7 mm to 12 mm.

64. The microscope objective of Example 1, wherein the most proximal two lens elements in said multiple lens elements in said third stage have clear apertures of at least 40 mm.

65. The microscope objective of Example 1, wherein the most proximal two lens elements in said multiple lens elements in said third stage have clear apertures of at least 44 mm.

66. The microscope objective of Example 1, wherein said multiple lens elements in said third stage has chromatic aberration to compensate for chromatic aberration contributed by refractive optics in the microscope objective.

67. The microscope objective of Example 1, wherein said multiple lens elements in said third stage has chromatic aberration to compensate for chromatic aberration in all said other refractive optics in the microscope objective.

68. The microscope objective of Example 1, wherein one or more surfaces on one or more lenses or lens elements comprise an aspheric surface.

69. The microscope objective of Example 1, wherein one or more lenses or lens elements comprise an aspheric lens or aspheric lens element.

70. The microscope objective of Example 1, wherein one or more surfaces on one or more lenses or lens elements comprise a diffractive optical element.

71. The microscope objective of Example 1, wherein one or more lens or lens elements comprise a diffractive optical element.

72. The microscope objective of Example 1, further comprising an additional lens element.

73. The microscope objective of Example 1, having a retrofocus factor of from 0.25 to 1.0.

74. The microscope objective of Example 1, wherein the number of lens elements is in the microscope objective is seven and only seven.

75. The microscope objective of Example 1, wherein the number of lens elements is more than seven.

76. The microscope objective of Example 1, wherein the number of lens elements is in the microscope objective is eight and only eight.

77. The microscope objective of Example 1, wherein the number of lens elements is in the microscope objective is six and only six.

78. The microscope objective of Example 1, wherein said microscope objective comprises no more than four lenses.

79. The microscope objective of Example 1, wherein said microscope objective comprises four lenses and only four lenses.

80. A laser manufacturing system comprising the microscope objective of Example 1.

81. A 3D printer comprising the microscope objective of Example 1.

82. A two photon polymerization system comprising the microscope objective of Example 1.

83. The microscope objective of Example 1, wherein said working distance is from 8 mm to 12 mm.

84. The microscope objective of Example 1, wherein said working distance is from 8 mm to 11 mm.

85. The microscope objective of Example 1, wherein said working distance is from 8 mm to 10 mm.

### Part II-B

1. A microscope objective having a first proximal end and a second distal end, said distal end configured to be closer to a sample than said proximal end, said microscope objective comprising:
seven lens elements having optical power within a housing arranged along a longitudinal optical path, said seven lens elements comprising:
   a first lens element having negative optical power,
   a second lens element having positive optical power,
   a third lens element having positive optical power, said second lens element between said first lens element and said third lens element;
   a lens triplet comprising a fourth lens element, a fifth lens element, and a sixth lens, with said fifth lens element between said fourth lens element and said sixth lens element, said fourth and sixth lens elements having positive optical power and the fifth lens element having negative optical power; and
   a seventh lens element positioned to be closest said sample, said seventh lens element having positive optical power, said triplet between said seventh lens element and said third lens element,
wherein said microscope objective has a working distance in a range from 5 mm to 16 mm and a numerical aperture of in a range from 0.50 to 0.65 in air.

2. The microscope objective of Example 1, wherein said working distance is from 6 to mm.

3. The microscope objective of Example 1, wherein said working distance is from 7 to mm.

4. The microscope objective of Example 1, wherein said working distance is from 7 to mm.

5. The microscope objective of Example 1, wherein said numerical aperture is in a range from 0.55 to 0.65.

6. The microscope objective of Example 1, wherein said numerical aperture is in a range from 0.57 to 0.63.

7. The microscope objective of Example 1, wherein said numerical aperture is in a range from 0.59 to 0.61.

8. The microscope objective of Example 1, wherein the first lens element comprises first and second surfaces, said first surface more proximal than said second surface, wherein said first surface has the highest curvature of any of the optical surfaces in said microscope objective.

9. The microscope objective of Example 1, wherein said first lens element has first and second surfaces, said second surface more distal than said first surface, wherein said second surface comprises a concave surface.

10. The microscope objective of Example 9, wherein said second surface has a curvature greater than 1/300 mm⁻¹.

11. The microscope objective of Example 9, wherein said second surface has a curvature greater than 1/100 mm⁻¹.

12. The microscope objective of Example 1, wherein said first lens element has a lateral extent larger than 20 millimeters.

13. The microscope objective of Example 1, wherein said first lens element has a lateral extent at least 40 millimeters.

14. The microscope objective of Example 1, wherein said first lens element is a biconcave lens.

15. The microscope objective of Example 1, wherein said second lens element has first and second surfaces, said second surface more distal than said first surface, wherein said first surface comprises a convex surface.

16. The microscope objective of Example 15, wherein said first surface has a curvature greater than 1/300 mm⁻¹.

17. The microscope objective of Example 15, wherein said first surface has a curvature greater than 1/100 mm⁻¹.

18. The microscope objective of Example 1, wherein said second lens element is a biconvex lens element.

19. The microscope objective of Example 1, wherein said first and second lens elements are combined together to form a lens doublet.

20. The microscope objective of Example 19, wherein said doublet has a clear aperture larger than 36 mm.

21. The microscope objective of Example 19, wherein said doublet has a clear aperture larger than 38 mm.

22. The microscope objective of Example 1, wherein said third lens element is separated from said second lens by a gap of at least 6 mm.

23. The microscope objective of Example 1, wherein the third lens element is configured to move with respect to said fourth lens.

24. The microscope objective of Example 1, wherein said third lens element is a biconvex lens.

25. The microscope objective of Example 1, wherein said third lens element has a proximal surface having a curvature of greater than 1/150 mm⁻¹.

26. The microscope objective of Example 1, wherein said third lens element has a distal surface having a curvature of less than 1/100 mm⁻¹.

27. The microscope objective of Example 1, wherein said third lens element has a thickness of at least 9 mm.

28. The microscope objective of Example 1, wherein said third lens element has a clear aperture of at least 40 mm.

29. The microscope objective of Example 1, wherein said third lens element has a clear aperture of at least 43 mm.

30. The microscope objective of Example 1, wherein said fourth and sixth lens elements are biconvex and said fifth lens element is biconcave.

31. The microscope objective of Example 1, wherein said triplet has a clear aperture of at least 35 mm.

32. The microscope objective of Example 1, wherein said triplet has a clear aperture of at least 38 mm.

33. The microscope objective of Example 1, wherein said fifth lens element has a distal surface with a curvature of greater than 1/50 mm⁻¹.

34. The microscope objective of Example 1, wherein said seventh lens element is a meniscus lens.

35. The microscope objective of Example 1, wherein one of said fourth and sixth lens elements have Abbe number that are at least twice as large as the Abbe number of the fifth lens element.

36. The microscope objective of Example 1, wherein said seventh lens element has a thickness of at least 12 mm.

37. The microscope objective of Example 1, wherein said seventh lens element has the smallest clear aperture of said seven lens elements.

38. The microscope objective of Example 1, wherein said seventh lens element has the most positive optical power of said seven lens elements.

39. The microscope objective of Example 1, wherein said seventh lens element has the most optical power of said seven lens elements.

40. The microscope objective of Example 1, wherein said third lens element has a clear aperture at least as large or larger than the clear aperture of seven lens elements.

41. The microscope objective of Example 1, wherein said microscope objective is configured to accommodate a scan angle of ±4°.

42. The microscope objective of Example 1, wherein said microscope objective is configured to have a field of view of 2.3 mm×2.3 mm.

43. The microscope objective of Example 1, wherein said microscope objective has a focal length of from 14 mm to 25 mm.

44. The microscope objective of Example 1, further comprising a housing for said first through seventh lens elements with M32×0.75 threads at the proximal end.

45. The microscope objective of Example 1, further comprising a housing that has a lateral spatial extent of greater than 50 mm.

46. The microscope objective of Example 1, further comprising a housing that has a lateral spatial extent of at least 60 mm.

47. The microscope objective of Example 1, wherein said microscope objective has an entrance pupil that is in the range from 18 mm to 22 mm in lateral extent.

48. The microscope objective of Example 1, wherein said first and second lens elements together have a thickness of at least 20 mm.

49. The microscope objective of Example 1, wherein said first and second lens elements together have a thickness of at least 25 mm.

50. The microscope objective of Example 1, wherein said seventh lens element has a thickness of at least 12 mm.

51. The microscope objective of Example 1, wherein said microscope objective is diffraction limited for at least one wavelength.

52. The microscope objective of Example 1, wherein said microscope objective provides for non-immersion in vivo imaging.

53. The microscope objective of Example 1, included in a microscope so as to provide a magnification of from 8× to 15×.

54. The microscope objective of Example 1, included in a fluorescent microscope having a light source outputting light having a wavelength, said microscope being diffraction limited for said wavelength.

55. The microscope objective of Example 1, wherein said microscope objective comprises no more than seven lens elements having optical power.

56. A microscope including said microscope objective of Example 1, said microscope including a light source configured to direct light through the microscope objective to the sample.

57. The microscope of Example 56, wherein said microscope comprises a laser scanning microscope, a fluorescence microscope, a two-photon laser scanning microscope, three-photon microscopy, harmonics-generation microscopy, Raman scattering (SRS) microscopy, coherent anti-stoke Raman scattering (CARS) microscopy, or nonlinear microscopy or a short wave infrared (SWIR) microscope.

58. The microscope objective of Example 1, wherein said microscope objective comprises an air objective.

59. The microscope objective of Example 1, wherein said microscope objective has a NA in air at from 0.55 to 0.65.

60. The microscope objective of Example 1, wherein said microscope objective has a working distance in air of from 8 to 12 mm.

61. The microscope objective of Example 1, wherein said fourth, fifth and sixth lens elements in said third stage have chromatic aberration to compensate for chromatic aberration in other lens elements in the microscope objective.

62. The microscope objective of Example 1, wherein said fourth, fifth and sixth lens elements in said third stage have chromatic aberration to compensate for chromatic aberration in all said other lens elements in the microscope objective.

63. The microscope objective of Example 1, wherein one or more surfaces on one or more lens elements comprise an aspheric surface.

64. The microscope objective of Example 1, wherein one or more lens elements comprise an aspheric lens or aspheric lens element.

65. The microscope objective of Example 1, wherein one or more surfaces on one or more lens elements comprise a diffractive optical element.

66. The microscope objective of Example 1, wherein one or more lens elements comprise a diffractive optical element.

67. The microscope objective of Example 1, having a retrofocus factor of from 0.25 to 1.0.

68. The microscope objective of Example 1, wherein the number of lens elements is in the microscope objective is seven and only seven.

69. The microscope objective of Example 1, wherein the number of lens elements is more than seven.

70. The microscope objective of Example 1, wherein the number of lens elements is in the microscope objective is eight and only eight.

71. The microscope objective of Example 1, wherein said microscope objective comprises no more than four lenses.

72. The microscope objective of Example 1, wherein said microscope objective comprises four lenses and only four lenses.

73. A laser manufacturing system comprising the microscope objective of Example 1.

74. A 3D printer comprising the microscope objective of Example 1.

75. A two photon polymerization system comprising the microscope objective of Example 1.

76. The microscope objective of Example 1, wherein said working distance is from 8 mm to 11 mm.

77. The microscope objective of Example 1, wherein said working distance is from 8 mm to 10 mm.

### Part III-B

1. A microscope objective having a first proximal end and a second distal end, said distal end configured to be closer to a sample than said proximal end, said microscope objective comprising:
a housing; and
a plurality of lens elements having optical power within said housing arranged along a longitudinal optical path within said housing, said plurality of lens elements including a lens element closest to the proximal end, a lens element closest to said distal end and a plurality of lens elements therebetween,
wherein said microscope objective has a working distance in the range from 5 mm to 16 mm and a numerical aperture in the range from 0.55 to 0.65 in air.

2. The microscope objective of Example 1, wherein said lens elements have clear apertures of greater than 18 mm.

3. The microscope objective of Example 1, wherein each of said lens elements has a clear aperture of at least 24 mm.

4. The microscope objective of Example 1, wherein each of said lenses has a clear aperture of at least 28 mm.

5. The microscope objective of Example 1, wherein each of said lenses has a clear aperture of at least 32 mm.

6. The microscope objective of Example 1, wherein at least one of said lens elements has a clear aperture of larger than 35 mm.

7. The microscope objective of Example 1, wherein at least one of said lens elements has a clear aperture of larger than 43 mm.

8. The microscope objective of Example 1, wherein at least some of the lens elements between the lens element closest to the proximal and the lens element closest to the distal ends have clear apertures of at least 30 mm.

9. The microscope objective of Example 1, wherein said plurality of lens elements comprise at least six of said lens elements having a clear aperture of greater than 30 mm.

10. The microscope objective of Example 1, wherein plurality of lens elements comprise at least seven of said lens elements having a clear aperture of greater than 30 mm.

11. The microscope objective of Example 1, wherein each of the lens elements between the lens elements closest to the proximal and distal ends have clear apertures of larger than 33 mm.

12. The microscope objective of Example 1, wherein each of the lens elements between the lens elements closest to the proximal and distal ends have clear apertures of larger than 35 mm.

13. The microscope objective of Example 1, wherein at least three lens elements have clear apertures of at least 40 mm.

14. The microscope objective of Example 1, wherein at least one of said lens elements has a clear aperture of larger than 42 mm.

15. The microscope objective of Example 1, wherein at least one of said lens elements has a clear aperture of at least 44 mm.

16. The microscope objective of Example 1, wherein said plurality of lens elements comprise 7 lens elements and said microscope objective includes no more than 7 lens elements.

17. The microscope objective of Example 1, wherein at least three of said lens elements are included in a triplet.

18. The microscope objective of Example 17, wherein said triplet has chromatic aberration to compensate for chromatic aberration in other lens elements in the microscope objective.

19. The microscope objective of Example 17, wherein said triplet has chromatic aberration to compensate for chromatic aberration in other all other lens elements in the microscope objective.

20. The microscope objective of Example 1, wherein at least two of said lens elements are included in a doublet.

21. The microscope objective of Example 1, wherein said plurality of lens elements comprise 6 lens elements and said microscope objective includes no more than 6 lens elements.

22. The microscope objective of Example 21, wherein at least one of said lens elements has an aspheric optical surface.

23. The microscope objective of Example 1, wherein said microscope objective has a working distance of between 6 mm and 15 mm.

24. The microscope objective of Example 1, wherein said microscope objective has a numerical aperture of between 0.58 to 0.61.

25. The microscope objective of Example 1, wherein said microscope objective is diffraction limited for at least one wavelength.

26. The microscope objective of Example 1, wherein said microscope objective has less than 0.1 wave of RMS wavefront error for at least one wavelength over a field of ±2°.

27. The microscope objective of Example 1, wherein said microscope objective has less than 0.1 wave of RMS wavefront error for at least one wavelength over a field of ±4°.

28. The microscope objective of Example 1, wherein said microscope objective has less than 0.1 wave of RMS wavefront error over a range of wavelength of at least 20 nm over a field of ±2°.

29. The microscope objective of Example 1, wherein said microscope objective has less than 0.1 wave of RMS wavefront error over a range of wavelength of at least 20 nm over a field of ±4°.

30. The microscope objective of Example 1, wherein said microscope objective has less than 0.06 wave of RMS wavefront error for at least one wavelength over a field of ±2°.

31. The microscope objective of Example 1, wherein said microscope objective has less than 0.06 wave of RMS wavefront error for at least one wavelength over a field of ±4°.

32. The microscope objective of Example 1, wherein said microscope objective has less than 0.06 wave of RMS wavefront error over a range of wavelength of at least 20 nm over a field of ±2°.

33. The microscope objective of Example 1, wherein said microscope objective has less than 0.06 wave of RMS wavefront error over a range of wavelength of at least 20 nm over a field of ±4°.

34. The microscope objective of Example 1, wherein said microscope objective has a Strehl ratio of at least 0.8 for at least one wavelength at over field of ±2°.

35. The microscope objective of Example 1, wherein said microscope objective has a Strehl ratio of at least 0.8 for at least one wavelength over a field of ±4°.

36. The microscope objective of Example 1, wherein said microscope objective has a Strehl ratio of at least 0.93 for at least one wavelength at a field of ±2°.

37. The microscope objective of Example 1, wherein said microscope objective has a Strehl ratio of at least 0.93 for at least one wavelength at a field of ±4°.

38. The microscope objective of Example 1, wherein said microscope objective has a Strehl ratio of at least 0.8 for over a wavelength range of at least 20 nm over field of ±2°.

39. The microscope objective of Example 1, wherein said microscope objective has a Strehl ratio of at least 0.8 over a wavelength range of at least 20 nm over a field of ±4°.

40. The microscope objective of Example 1, wherein said microscope objective has a Strehl ratio of at least 0.93 over a wavelength range of at least 20 nm over a field of ±2°.

41. The microscope objective of Example 1, wherein said microscope objective has a Strehl ratio of at least 0.93 over a wavelength range of at least 20 nm over a field of ±4°.

42. The microscope objective of Example 1, included in a microscope so as to provide a magnification of from 8× to 16×.

43. The microscope objective of Example 1, included in a microscope so as to provide a magnification of from 9× to 15×.

44. The microscope objective of Example 1, further comprising a housing for said first through fourth stages with M32×0.75 threads at the proximal end.

45. The microscope objective of Example 1, included in a fluorescent microscope having a light source outputting light having a wavelength, said microscope being diffraction limited for said wavelength.

46. A microscope including said microscope objective of Example 1, said microscope including a light source configured to direct light through the microscope objective to the sample.

47. The microscope of Example 44, wherein said microscope comprises a laser scanning microscope, a fluorescence microscope, a two-photon laser scanning microscope, three-photon microscopy, harmonics-generation microscopy, Raman scattering (SRS) microscopy, coherent anti-stoke Raman scattering (CARS) microscopy, or nonlinear microscopy or a short wave infrared (SWIR) microscope.

48. The microscope objective of Example 1, wherein the lens element closest to said proximal end or the lens element closest to the distal end is the smallest.

49. The microscope objective of Example 1, wherein the lens element closest to said proximal end has negative optical power.

50. The microscope objective of Example 1, wherein the lens element closest to the distal end has positive optical power.

51. The microscope objective of Example 1, wherein at least some of the lens elements have clear apertures of at least 30 mm.

52. The microscope objective of Example 1, wherein at least some of the lens elements between the lens element closest to the proximal and the lens element closest to the distal ends have clear apertures of at least 30 mm.

53. The microscope objective of Example 1, wherein each of the lens elements between the lens element closest to the proximal and the lens element closest to the distal ends have clear apertures of larger than 30 mm.

54. The microscope objective of Example 1, wherein said microscope objective comprises no more than four lenses.

55. The microscope objective of Example 54, wherein one of said lens comprises a doublet comprising two lens elements and one of said lenses comprises a triplet comprising three lens elements.

56. The microscope objective of Example 1, wherein said microscope objective comprises no more than three lenses.

57. The microscope objective of Example 1, wherein said microscope objective comprises an air objective.

58. The microscope objective of Example 1, wherein said microscope objective has a working distance in air of from 6 to 14 mm.

59. The microscope objective of Example 1, wherein said microscope objective has a NA in air of from 0.55 to 0.65.

60. The microscope objective of Example 1, wherein said microscope objective diffraction limited in air between 910 nm and 1060 nm.

61. The microscope objective of Example 1, wherein said microscope objective diffraction limited in air between 910 nm and 1100 nm.

62. A microscope comprising the microscope objective of Example 1, wherein said microscope comprises a multiphoton laser scanning microscope configured for in vivo imaging.

63. A microscope comprising the microscope objective of Example 1, wherein said microscope comprises a multiphoton laser scanning microscope configured for in physiology imaging.

64. A microscope comprising the microscope objective of Example 1, wherein said microscope comprises a multiphoton laser scanning microscope configured to operate at a wavelength in the wavelength range of 900-1100 nm.

65. A microscope comprising the microscope objective of Example 1, wherein said microscope comprises a multiphoton laser scanning microscope configured to operate at a Near Infrared (NIR) wavelength.

66. The microscope objective of Example 1, wherein one or more surfaces on one or more lens elements comprise an aspheric surface.

67. The microscope objective of Example 1, wherein one or more lens elements comprise an aspheric lens or aspheric lens element.

68. The microscope objective of Example 1, wherein one or more surfaces on one or more lens elements comprise a diffractive optical element.

69. The microscope objective of Example 1, wherein one or more lens elements comprise a diffractive optical element.

70. The microscope objective of Example 1, wherein the number of lens elements is in the microscope objective is seven and only seven.

71. The microscope objective of Example 1, wherein the number of lens elements is more than seven.

72. The microscope objective of Example 1, wherein the number of lens elements is in the microscope objective is eight and only eight.

73. The microscope objective of Example 1, wherein the number of lens elements is less than seven.

74. The microscope objective of Example 1, wherein said microscope objective comprises four lenses and only four lenses.

75. The microscope objective of Example 1, wherein said microscope objective comprises three lenses and only three lenses.

76. The microscope objective of Example 1, having a retrofocus factor of from 0.25 to 1.0.

77. A laser manufacturing system comprising the microscope objective of Example 1.

78. A 3D printer comprising the microscope objective of Example 1.

79. A two photon polymerization system comprising the microscope objective of Example 1.

80. The microscope objective of Example 1, wherein said working distance is from 7 mm to 13 mm.

81. The microscope objective of Example 1, wherein said working distance is from 7 mm to 12 mm.

82. The microscope objective of Example 1, wherein said working distance is from 7 mm to 11 mm.

83. The microscope objective of Example 1, wherein said working distance is from 8 mm to 12 mm.

84. The microscope objective of Example 1, wherein said working distance is from 8 mm to 11 mm.

85. The microscope objective of Example 1, wherein said working distance is from 8 mm to 10 mm.

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

What is claimed is:

1. A microscope objective having a first proximal end and a second distal end, said distal end configured to be closer to a sample than said proximal end, said microscope objective comprising:
a first stage comprising a diverging lens element having negative optical power such that collimated light incident on said diverging lens element is caused by said diverging lens element to diverge as said light propagates away from said diverging lens element in the direction of said distal end of said microscope objective;
a second stage comprising a lens configured to receive said diverging beam and to cause the diverging beam to begin to converge from the widest lateral extent of the beam in the microscope objective or be collimated, said second stage more distal than said first stage;
a third stage comprising multiple lens elements, said third stage more distal than said second stage such that said lens in said second stage is located between said diverging lens element in said first stage and said multiple lens elements in said third stage; and
a fourth stage comprising a distal focusing lens having positive optical power to focus the beam down, said distal focusing lens being the lens that is closest to the focus of said microscope objective where said collimated light incident on the proximal end of said microscope objective will be focused, said fourth stage being more distal than said third stage such multiple lens elements in said third stage is between said lens in said second stage and said distal focusing lens in said fourth stage,
wherein said microscope objective has a numerical aperture in the range from 0.55 to 0.65.

2. The microscope objective of claim 1, wherein said diverging lens element in said first stage comprises first and second surfaces, said first surface more proximal than said second surface, wherein said first surface has the highest curvature of any of the optical surfaces in said microscope objective.

3. The microscope objective of claim 1, wherein said diverging lens element in the first stage has first and second surfaces, said second surface more distal than said first surface, wherein said second surface comprises a concave surface.

4. The microscope objective of claim 1, wherein said diverging lens element has a clear aperture at least 36 mm.

5. The microscope objective of claim 1, wherein said first stage further comprises a positive lens element.

6. The microscope objective of claim 5, wherein said pair of said diverging lens element and said positive lens element in the first stage together having negative optical power.

7. The microscope objective of any of claim 5, wherein said positive lens element in the first stage has first and second surfaces, said second surface more distal than said first surface, wherein said first surface comprises a convex surface.

8. The microscope objective of claim 1, wherein said lens element in said first stage and/or said lens in said second stage are configured to move with respect to said third stage.

9. The microscope objective of claim 1, wherein said lens in said second stage comprises by biconvex lens.

10. The microscope objective of claim 1, wherein said lens in said second stage has a thickness of at least 9 mm.

11. The microscope objective of claim 1, wherein said lens in said second stage has a clear aperture of at least 40 mm.

12. The microscope objective of claim 1, wherein said multiple lens elements comprises three lens elements: a first positive lens element, a second negative lens element, and a third positive lens element, with the second negative lens element between the first and third positive lens elements.

13. The microscope objective of claim 1, wherein multiple lens elements together has a clear aperture of at least 38 mm.

14. The microscope objective of claim 1, wherein said multiple lens elements together has a clear aperture of at least 40 mm.

15. The microscope objective of claim 1, wherein said distal focusing lens in said fourth stage comprises a meniscus lens.

16. The microscope objective of claim 1, wherein said distal focusing lens in said fourth stage has a thickness of at least 12 mm.

17. The microscope objective of claim 1, wherein said microscope objective has a working distance of from 5 mm to 15 mm.

18. The microscope objective of claim 1, further comprising a housing that has a lateral spatial extent of greater than 60 mm.

19. The microscope objective of claim 1, wherein said microscope objective is diffraction limited for at least one wavelength.

20. The microscope objective of claim 1, wherein said microscope objective has a working distance in air of from 7 mm to 12 mm.
